(19) United States
(12) Patent Application Publication
(10) Pub. No.: US 2007/0025348 A1
(43) Pub. Date: Feb. 1, 2007

(54) Network device and network system

(75) Inventors: Naoyuki Nakashima, Fukuoka (JP); Hirofumi Mitome, Fukuoka (JP); Kouji Sakata, Fukuoka (JP); Kazuhiro Nakashima, Fukuoka (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/247,694

(22) Filed: Oct. 11, 2005

(30) Foreign Application Priority Data
Jul. 29, 2005 (JP) 2005-220563

(51) Int. Cl. H04L 12/56

(52) U.S. Cl. 370/389; 370/395.31

(57) ABSTRACT

In a network device and a network system structuring a VLAN at the layer 2 level, a starting network device transmits a structuring packet including a port number corresponding to an address of a terminating network device and a single VLAN after having added thereto an address of the starting network device itself and a port number from which the structuring packet is outputted; a relaying network device transmits the structuring packet to which an address of the relaying network device itself, a port number to which the structuring packet has been inputted, and a port number from which the structuring packet is to be outputted are added; and a terminating network device transmits a setup packet in which port numbers are associated with the VLAN for each of the starting and the relaying network device to each of addresses of the starting and the relaying network device.

### BACKGROUND OF THE INVENTION

1. Field of the Invention

The present invention relates to a network device and a network system, and in particular to a network device and a network system structuring a virtual network (VLAN: Virtual Local Area Network) at the layer 2 level.

A virtual network is a virtual LAN structured per group such as an enterprise or an organization on a physical network structured by a carrier or the like, and is different from the physical network. Specifically, in order to structure a VLAN at the layer 2 level, it is required to perform a setting of associating VLANs with ports of all of the network devices on a path through which packets belonging to VLANs pass.

2. Description of the Related Art

Prior art (1)

FIG. 25 shows a generally-known layer 2 VLAN network. In this network, VLANs 31, 32, and 33 are structured on a physical network where network devices 100_1-100_7 (hereinafter, occasionally represented by a reference numeral 100) are physically and mutually connected. For structuring the VLANs, it is required to log in to all of the network devices 100 required for structuring the VLAN 31 from a console or the like (not shown) for example, and to manually incorporate setting process (process of associating a VLAN with a port) of configuring information concerning the VLAN 31 into the network devices 100. It is to be noted that FIG. 25 shows a tag VLAN, and to packets belonging to e.g. the VLAN 31 a tag indicating the VLAN 31 is added, so that the network devices 100 transmit the packets received to a port corresponding to the tag VLAN 31.

Prior art (2)

Also, a VPN (Virtual Private Network: see e.g. patent document 1) is configured by connecting a plurality of VLANs by a carrier network (i.e. through edge routers arranged over the carrier network) so that the VLANs look like a single VLAN. In this VPN, the edge routers respectively store the route information received in a route table of the corresponding VPN, and notify the other edge routers of the route information by a route information communication means independent for each VPN. The other edge routers having received the route information select the corresponding VPN, and store the route information in the route table of the selected VPN. Thus, it becomes unnecessary to extend a BGP protocol (extension by adding the VPN identifier), so that an existing router can be utilized. However, concerning a VLAN setup, a manual setting similar to the prior art (1) is required.

[Patent Document 1] Japanese Patent Application Laid-open No. 2002-208946 (Page 3 and 4, FIG. 1)

Manual VLAN setup processing hardly becomes an issue in a case where the number of network devices is small or where the number of VLANs to be set up is small. However, when the number of network devices becomes large and a network scale is large, it is required to set up from tens to hundreds of VLANs, which leads to heavy burden for an operator. Namely, it is difficult for the operator to grasp many topologies different in quality corresponding to the VLANs, so that it requires time and labor for the VLAN setup, leading to a high possibility of an occurrence of operational mistakes. Also, the operational mistakes having occurred, an occurrence of troubles due to the operational mistakes involving other networks, a trouble shooting for resolving the mistakes and troubles, and the like constitute a large cost factor.

### SUMMARY OF THE INVENTION

It is accordingly an object of the present invention to provide a network device structuring a VLAN at the layer 2 level, in which a VLAN setup is facilitated.

In order to achieve the above-mentioned object, a starting network device according to the present invention comprises: a packet transmitter transmitting a structuring packet for structuring a single VLAN after having added thereto an address of the device itself and a port number from which the structuring packet is outputted; a VLAN setup table; a packet receiver receiving a setup packet addressed to the device itself in which the port number and the VLAN are associated with each other from a terminating network device designated by the structuring packet; and a VLAN setup portion setting the received port number and the VLAN associated with each other in the VLAN setup table.

FIG. 1 shows an operation principle of network devices 100 (generally referring to reference numerals 100_1-100_7) according to the present invention configuring a network. This network is composed of the network devices 100_3, 100_1, 100_2, and 100_6 connected in series, the network device 100_4 connected to the network device 100_1, and the network devices 100_5 and 100_7 connected to the network device 100_2. Hereinafter, the network device 100_1 transmitting a VLAN structuring packet 701 is referred to as a starting network device (or starting device), the network device 100_2 relaying the VLAN structuring packet is referred to as a relaying network device (or relaying device), and the network devices 100_3-100_7 terminating the VLAN structuring packet are referred to as terminating network devices (or terminating devices). Also, each network device is provided with a VLAN setup table (not shown).

When e.g. a VLAN 31 is set up between a port No. 1 of the terminating device 100_3 and a port No. 1 of the terminating device 100_6 (see hatched portion in FIG. 1), the VLAN 31 is associated with each port No. 1 in the VLAN setup table of both network devices 100. Furthermore, port Nos. (not shown) of the network devices 100_3, 100_1, 100_2, and 100_6 passed through from the port No. 1 of the terminating device 100_3 to the port No. 1 of the terminating device 100_6 are respectively associated with the VLAN 31 in the VLAN setup table of the concerned network device.

The starting network device 100_1 according to the present invention is provided with a packet transmitter, a VLAN setup table, a setup packet receiver, and a VLAN setup portion (none is shown). When the above-mentioned VLAN 31 is set up in the network, for example, the packet transmitter transmits the VLAN structuring packet 701 including an address of the terminating network device 100_6 and the port No. “1 (which corresponds to the VLAN 31)” after having added thereto the address of the device 100_1 itself and the port No. (from which the VLAN structuring packet 701 is outputted) (see T1 in FIG. 1). When the packet receiver receives a setup packet 702 addressed to the device itself associating the port No. with the VLAN 31 from the terminating network device 100_6, the VLAN setup portion associates the port No. (received by the VLAN setup packet) with the VLAN 31 (received by the VLAN setup packet) to be set in the VLAN setup table (see T4 in FIG. 1). Thus, the VLAN setup is facilitated.

Also, the starting network device may further comprise a VLAN information accepting portion inputting from an external device an address of the terminating network device and a port number on a terminal side corresponding to the VLAN to be inserted into the above-mentioned structuring packet.

Namely, as shown in FIG. 1, the operator can directly or remotely access a VLAN information accepting portion of the network device from a console (external device) 300, and can input an address of the terminating network device and a port No. on a terminal side corresponding to the VLAN.

Also, the above-mentioned packet transmitter may broadcast the structuring packet. Thus, it becomes possible to transmit the structuring packet to all of the paths which can be reached from the starting network device within the network.

Also, the above-mentioned VLAN setup table may be related to an address learning table associating a port number with an address so that the VLAN is associated with the port number and the address.

Furthermore, when a port corresponding to an address of the terminating network device is learned in the address learning table, the above-mentioned packet transmitter may transmit the structuring packet to the learned port in place of broadcasting the structuring packet. Thus, it becomes unnecessary to transmit a useless structuring packet.

Also, in order to achieve the above-mentioned object, a relaying network device according to the present invention comprises: a structuring packet receiver receiving a structuring packet for structuring a single VLAN; a packet transmitter transferring the structuring packet to which an address of the device itself, a port number to which the structuring packet has been inputted, and a port number from which the structuring packet is to be outputted are added when an address of a terminating network device designated by the structuring packet is not coincident with the address of the relaying network device itself, a VLAN setup table; a setup packet receiver receiving from the terminating network device a setup packet addressed to the relaying network device itself in which both port numbers and the VLAN are associated with each other; and a VLAN setup portion setting the received port numbers and the VLAN associated with each other in the VLAN setup table.

Namely, in FIG. 1, the relaying network device 100_2 is provided with a structuring packet receiver, a packet transmitter, a VLAN setup table, a setup packet receiver, and a VLAN setup portion. The structuring packet receiver receives the structuring packet 701. The structuring packet 701 includes an address of the terminating network device and a port No. corresponding to a single VLAN, and the addresses and the port Nos. of the starting and the relaying network device. When the address of the device itself is not the address of the terminating network device, i.e. the device itself is not the terminating network device, the packet transmitter transfers the received structuring packet 701 to which the address of the device itself, a port No. to which the structuring packet 701 has been inputted, and a port No. from which the structuring packet 701 is to be outputted have been added (see step T2 in FIG. 1). The setup packet receiver receives the setup packet 702 addressed to the relaying device itself in which the port No. and the VLAN are associated. The VLAN setup portion associates the VLAN with the port No. received of the VLAN setup table to be set (see step T4 in FIG. 1). Thus, the VLAN setup is facilitated.

Also, the above-mentioned packet transmitter may broadcast the structuring packet. Thus, it becomes possible to transmit the structuring packet to all of the paths which can be reached from the relaying network devices within the network.

Also, the above-mentioned VLAN setup table may be related to an address learning table associating a port number with an address so that the VLAN is associated with the port number and the address.

Furthermore, when a port corresponding to an address of the terminating network device is learned in the address learning table, the above-mentioned packet transmitter may transmit the structuring packet to the learned port in place of broadcasting the structuring packet. Thus, a transmission of a useless structuring packet is eliminated.

Also, in order to achieve the above-mentioned object, a terminating network device comprises: a packet receiver receiving a structuring packet for structuring a single VLAN; a setup information extractor extracting, when an address of a terminating network device designated by the structuring packet is coincident with an address of the terminating network device itself, a port number to which the structuring packet has been inputted, a port number on a terminal side of the terminating network device corresponding to the VLAN designated by the structuring packet, the VLAN designated by the structuring packet, addresses of a starting and a relaying network device designated by the structuring packet, and port numbers of the starting and the relaying network device designated by the structuring packet; a packet transmitter transmitting for each of the starting and the relaying network device a setup packet in which a respective port number of each of the starting and the relaying network device is associated with the VLAN to each of addresses of the starting and the relaying network device; a VLAN setup table; and a VLAN setup portion setting in the VLAN setup table the port number to which the structuring packet has been inputted and the port number on the terminal side corresponding to the VLAN designated by the structuring packet associated with the VLAN.

Namely, in FIG. 1, e.g. the terminating network device 100_6 is provided with a packet receiver, a packet transmitter, a VLAN setup table, and a VLAN setup portion. The packet receiver receives the structuring packet 701 including an address of a terminating network device, a port No. corresponding to a single VLAN, and an address and a port No. of at least one other network device. When the address of the terminating network device designated by the structuring packet 701 is coincident with the address of the terminating device itself, a setup information extractor extracts a port No. (hereinafter, occasionally referred to as an output port No.) on a terminal side of the terminating network device corresponding to the VLAN designated by the port No. to which the structuring packet 701 has been inputted and the structuring packet 701, the VLAN designated by the structuring packet 701, the addresses of the starting and the relaying network device designated by the structuring packet, and the port Nos. of the starting and the relaying network device designated by the structuring packet. The packet transmitter transmits for each of starting and relaying network device a setup packet in which a respective port No. of each of the starting and the relaying network device is associated with the VLAN to each of addresses of the starting and the relaying network device. The VLAN setup portion sets in the VLAN setup table the port No. to which the structuring packet 701 has been inputted and the port No. (output port No.) on the terminal side corresponding to the VLAN designated by the structuring packet 701 associated with the VLAN (see step T5 in FIG. 1). Thus, the VLAN setup is facilitated.

Also, the above-mentioned VLAN setup table may be related to an address learning table associating a port number with an address so that the VLAN is associated with the port number and the address.

Furthermore, in order to achieve the above-mentioned object, a network system according to the present invention comprises: a starting network device transmitting a structuring packet for structuring a single VLAN after having added thereto an address of a terminating network device, a port number on a terminal side corresponding to the VLAN, an address of the starting network device itself, and a port number from which the structuring packet is outputted; and setting in a VLAN setup table of the starting network device itself a port number from which the structuring packet designated by a received setup packet addressed to the starting network device itself is outputted and the VLAN associated with each other; a relaying network device transferring, when an address of the terminating network device designated by the structuring packet received is not coincident with the address of the relaying network device itself, the structuring packet to which an address of the relaying network device itself, a port number to which the structuring packet has been inputted, and a port number from which the structuring packet is to be outputted are added; and setting in the VLAN setup table of the relaying network device itself a port number to which the structuring packet has been inputted and a port number from which the structuring packet has been outputted, both of which are designated by a received setup packet addressed to the relaying network device itself associated with the VLAN; and a terminating network device transmitting, when the address of the terminating network device designated by the structuring packet received is coincident with the address of the terminating network device itself, a setup packet in which port numbers for each of addresses of the starting and the relaying network device designated by the structuring packet are associated with the VLAN, to each of addresses of the starting and the relaying network device, and setting in the VLAN setup table of the terminating network device itself a port number to which the structuring packet has been inputted and a port number on a terminal side corresponding to the VLAN and added to the structuring packet associated with the VLAN.

As described above, by the network device according to the present invention, it becomes possible to facilitate the VLAN setup. Namely, in the conventional technology, it has been necessary that an operator grasping the overall network configuration performs a setup for structuring the VLAN for each of the network devices after having determined whether or not the VLAN setup is required for e.g. the ports 1 and 2 of the network device 100_1.

However, in the present invention, if only setup information (port No. and VLAN No.) for a terminating network device (network device which forms a starting point and a terminating point of a VLAN having a port corresponding to a VLAN on a terminal side) in a network, knowledges about the network configuration in the interim are not required. Accordingly, it becomes possible for an operator without the network knowledges to promptly and reliably structure the VLAN. Also, since it is not necessary to log in to all of the network devices and to perform the VLAN setup, time for the VLAN setup can be reduced. This reduction effect is increased as the number of network devices becomes large.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing a principle of a network device according to the present invention;

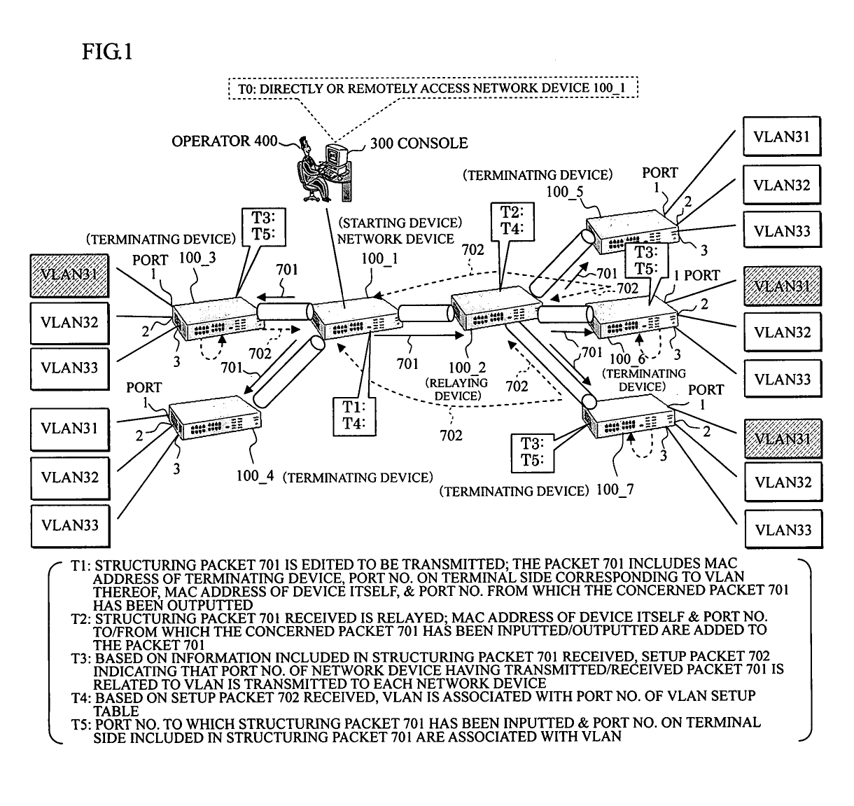

FIG. 2 is a block diagram showing an arrangement embodiment of a network device according to the present invention;

FIG. 3 is a block diagram showing an example of a network configuration in an operational embodiment (1) of a network device according to the present invention;

FIGS. 4A-4E are diagrams showing an example of a VLAN setup command in an operational embodiment (1) of a network device according to the present invention;

FIGS. 5A-5C are diagrams showing an example (1) of a VLAN structuring packet in an operational embodiment (1) of a network device according to the present invention;

FIGS. 6A-6C are diagrams showing an example (2) of a VLAN structuring packet in an operational embodiment (1) of a network device according to the present invention;

FIGS. 7A-7E are diagrams showing an example of a VLAN setup packet (associated with MAC address learning table) in an operational embodiment (1) of a network device according to the present invention;

FIGS. 8A-8D are diagrams showing an example of a VLAN setup table in an operational embodiment (1) of a network device according to the present invention;

FIG. 9 is a flowchart showing an operation procedure example of a VLAN information accepting portion in a network device according to the present invention;

FIG. 10 is a flowchart showing an operation procedure example of a VLAN structuring portion for other devices in a network device according to the present invention;

FIG. 11 is a flowchart showing an operation procedure example of a VLAN structuring packet transmitter in a network device according to the present invention;

FIG. 12 is a flowchart showing an operation procedure example of a VLAN structuring packet receiver in a network device according to the present invention;

FIG. 13 is a flowchart showing an operation procedure example of a VLAN structuring packet relay portion in a network device according to the present invention;

FIG. 14 is a flowchart showing an operation procedure example of a VLAN setup packet transmitter in a network device according to the present invention;

FIG. 15 is a flowchart showing an operation procedure example of a VLAN setup packet receiver in a network device according to the present invention;

FIG. 16 is a flowchart showing an operation procedure example of a VLAN setup portion for the network device itself in a network device according to the present invention;

FIG. 17 is a flowchart showing an operation procedure example of a command response transmitter in a network device according to the present invention;

FIG. 18 is a block diagram showing an example of a network configuration in an operational embodiment (2) of a network device according to the present invention;

FIGS. 19A-19C are diagrams showing an example of a VLAN setup command in an operational embodiment (2) of a network device according to the present invention;

FIGS. 20A and 20B are diagrams showing an example (1) of a VLAN structuring packet in an operational embodiment (2) of a network device according to the present invention;

FIGS. 21A-21C are diagrams showing an example (2) of a VLAN structuring packet in an operational embodiment (2) of a network device according to the present invention;

FIGS. 22A-22C are diagrams showing an example (3) of a VLAN structuring packet in an operational embodiment (2) of a network device according to the present invention;

FIGS. 23A-23H are diagrams showing an example of a VLAN setup packet in an operational embodiment (2) of a network device according to the present invention;

FIGS. 24A-24E are diagrams showing an example of a VLAN setup table (associated with MAC address learning table) in an operational embodiment (2) of a network device according to the present invention; and

FIG. 25 is a block diagram showing an example of a generally-known layer 2 VLAN network.

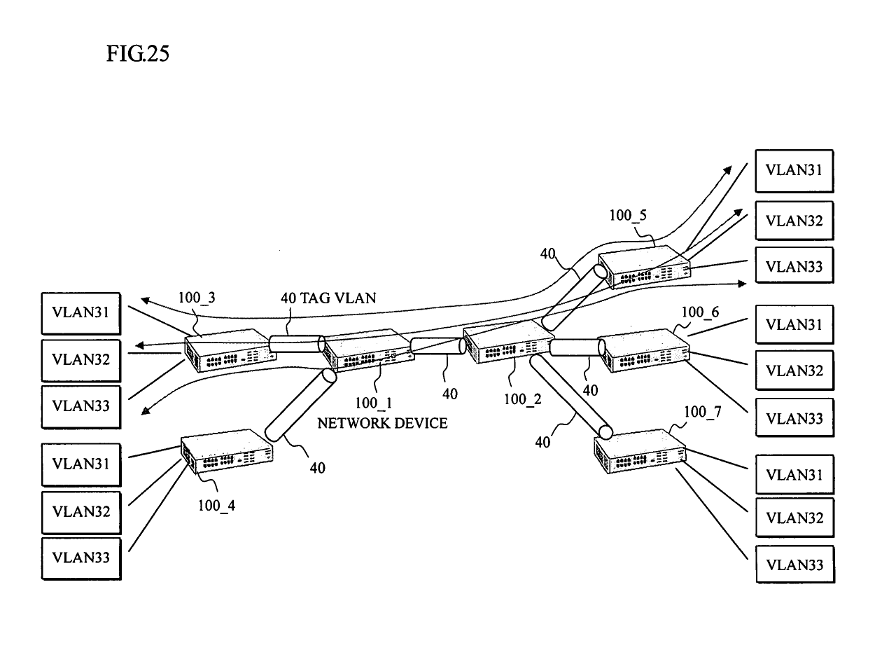

### DESCRIPTION OF THE EMBODIMENTS

### Arrangement Embodiment

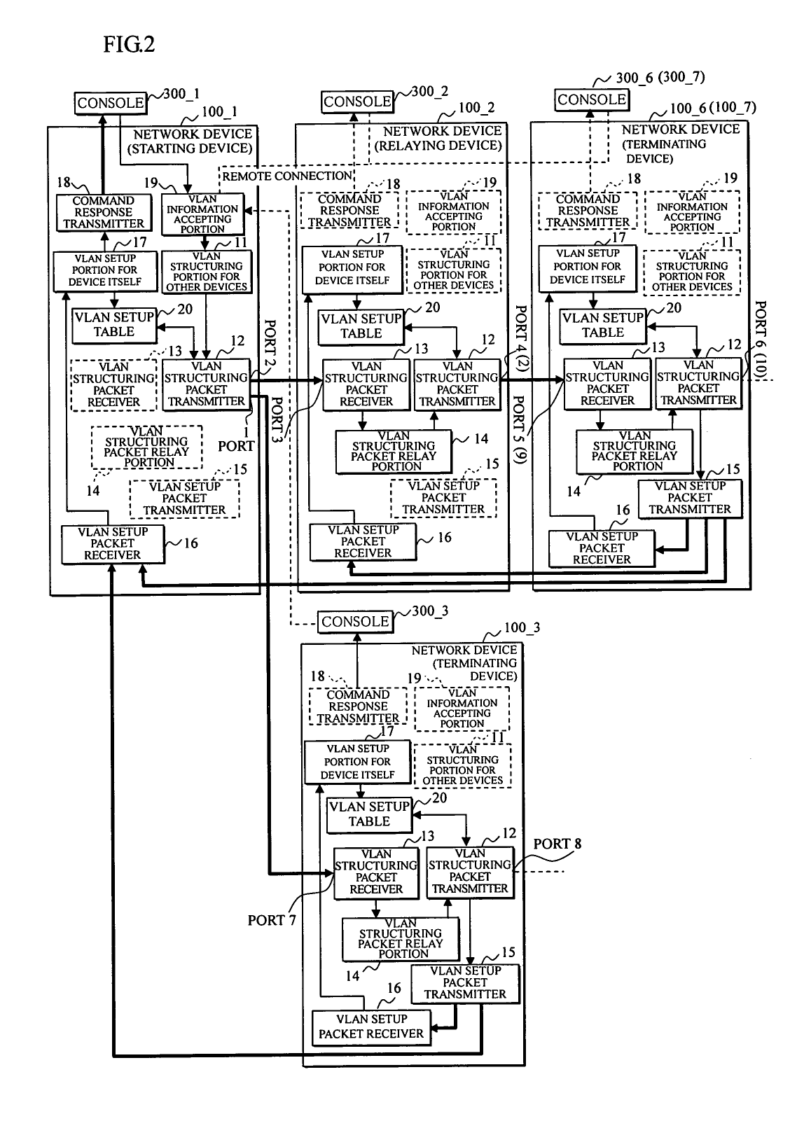

FIG. 2 shows an arrangement embodiment of the network device 100 (generally referring to reference numerals 100_1-100_7) of the present invention. FIG. 2 also shows a network configuration in a case where the network devices 100_1, 100_2, 100_3, 100_6, and 100_7 respectively operate as a starting device (transmitting a VLAN structuring packet) for setting up the VLAN, a relaying device (relaying the VLAN structuring packet), and a terminating device (terminating the VLAN structuring packet and also serving as a starting point/terminating point device of the VLAN). It is to be noted that the network devices 100_6 and 100_7 are indicated in the same block in FIG. 2.

Each network device 100 has the same arrangement, which is composed of a VLAN information accepting portion 19, a VLAN structuring portion for other devices 11, a VLAN structuring packet transmitter 12, a VLAN structuring packet receiver 13, a VLAN structuring packet relay portion 14, a VLAN setup packet transmitter 15, a VLAN setup packet receiver 16, a VLAN setup portion for the device itself 17, a command response transmitter 18, and a VLAN setup table 20. Also, consoles 300_1-300_3, 300_6, and 300_7 are respectively connected to the network devices 100_1-100_3, 100_6, and 100_7.

It is to be noted that when the network devices 100 respectively operate only as the starting device, the relaying device, and the terminating device, functional blocks shown by dotted lines within the network devices 100_1, 100_2, 100_3, 100_6, and 100_7 are not required.

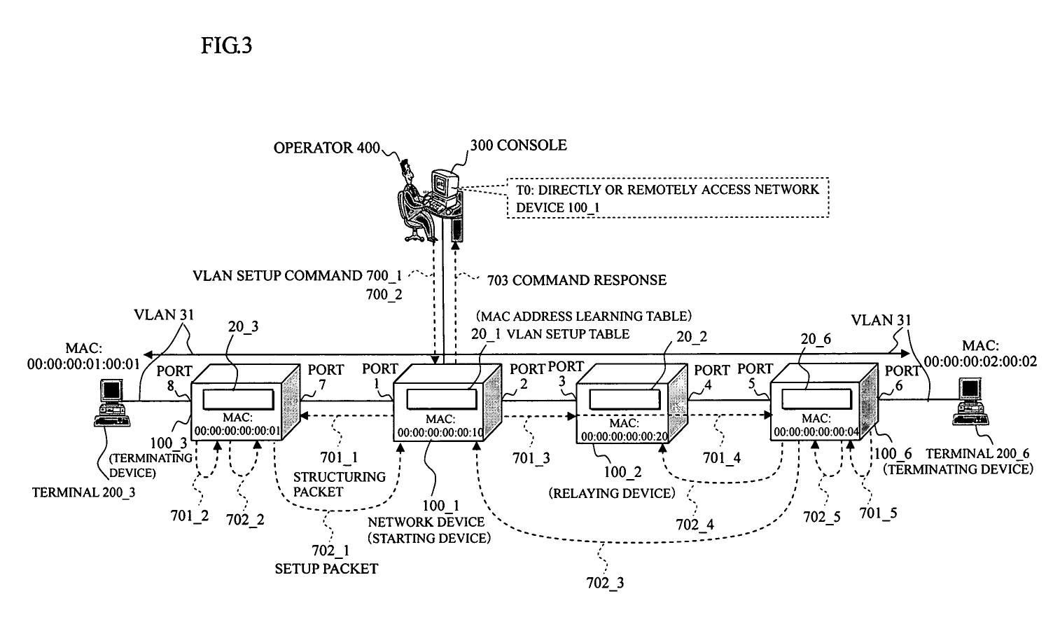

FIG. 3 shows in more detail a connection state of a network without the network device 100_7 in the network shown in FIG. 2. This network is a single network without a branch from the network (terminating device) device 100_3 to the network (terminating device) device 100_6. In this network, a terminal 200_3 is connected to a port 8 of the network device 100_3, a port 7 of the network device 100_3 is connected to a port 1 of the network device 100_1, a port 2 of the network device 100_1 is connected to a port 3 of the network device 100_2, a port 4 of the network device 100_2 is connected to a port 5 of the network device 100_6, and a terminal 200_6 is connected to a port 6 of the network device 100_6. Also, the console 300 is connected to the network device 100_1, so that an operator 400 directly or remotely accesses the network device 100_1 through the console 300.

Also, MAC addresses of the network devices 100_3, 100_1, 100_2, and 100_6 are respectively “00:00:00:00:00:01”, “00:00:00:00:00:10”, “00:00:00:00:00:20”, and “00:00:00:00:00:04”. MAC addresses of the terminals 200_3 and 200_6 are respectively “00:00:00:01:00:01” and “00:00:00:02:00:02”.

Also, FIG. 3 shows commands and packets transmitted/received when the VLAN 31 is set up between the terminals 200_3 and 200_6. The outline of the commands and the packets will now be described.
VLAN setup commands 700_1 and 700_2 (hereinafter, occasionally represented by a reference numeral 700): The operator 400 provides a command 700 to the network device 100_1 directly or remotely accessed through the console 300 and instructs setting up (routing) the VLAN 31.
VLAN structuring packets 700_1-701_5 (hereinafter, occasionally represented by a reference numeral 701): These packets are for collecting VLAN setup information (port No.) of the network devices 100.
VLAN setup packets 702_1-702_5 (hereinafter, occasionally represented by a reference numeral 702): These packets are for notifying a port No. corresponding to the VLAN to each network device 100 based on the VLAN setup information collected by the VLAN structuring packet 701. Each network device 100 having received the packet 702 performs a setting of associating the port No. with the VLAN 31 on the VLAN setup table 20 (associated with the MAC address learning table; see FIGS. 2 and 3) based on the VLAN setup information (VLAN and port No.) included in the packet 702.
Command response 703: This is a response for the above-mentioned VLAN setup command 700, and indicates that the setup of the VLAN 31 in the network device 100_1 has been completed.

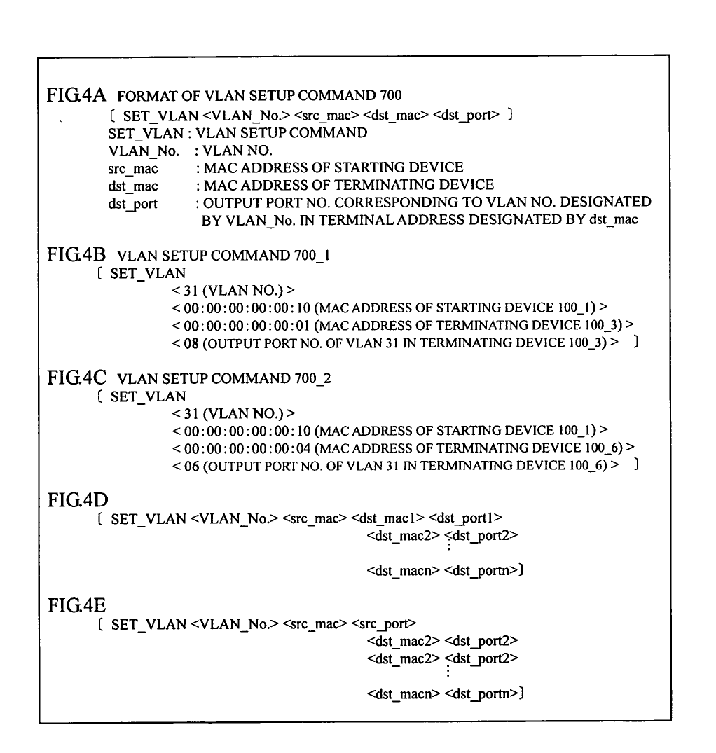

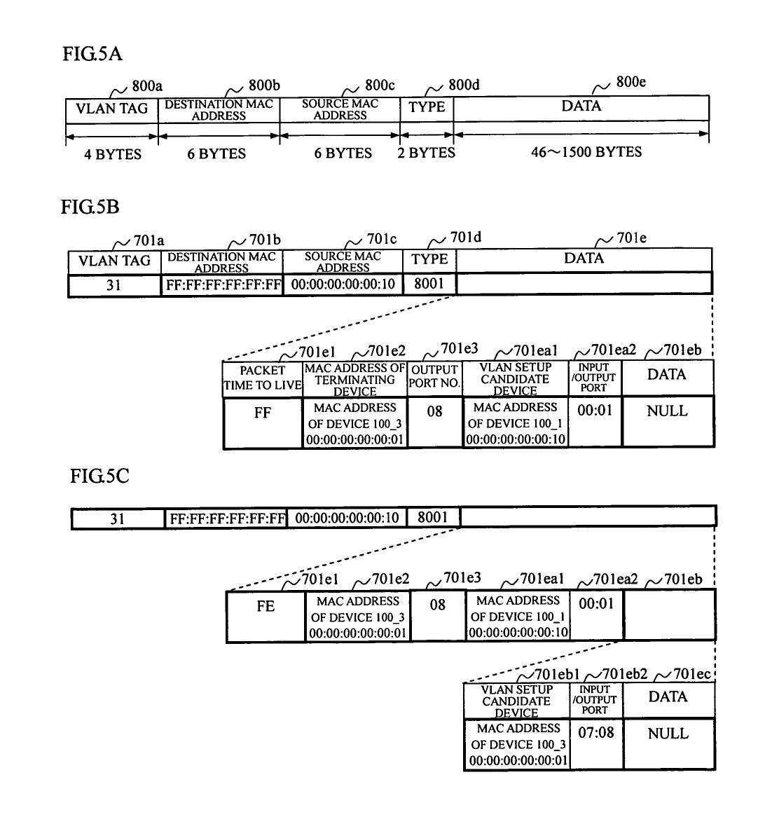

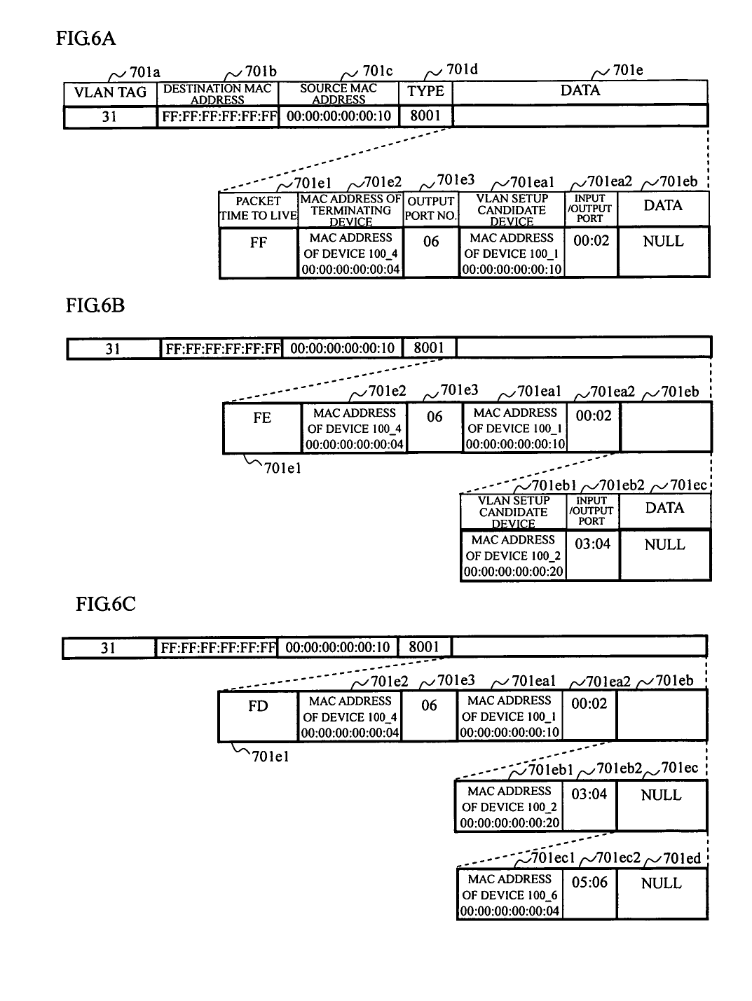

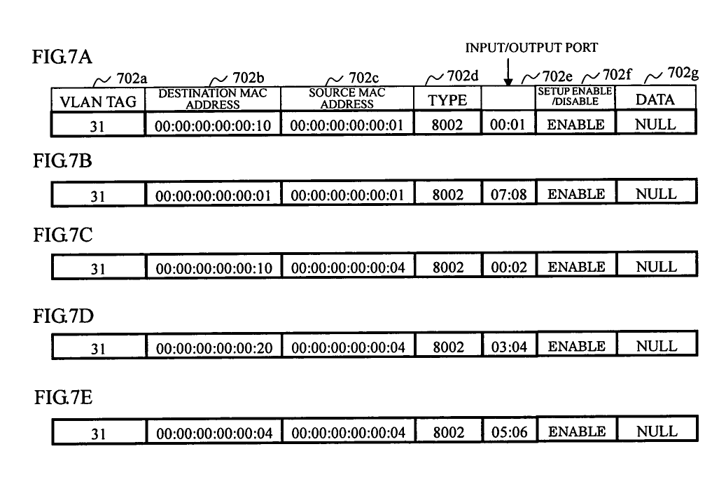

FIGS. 4A-4E show an example of the VLAN setup command 700. FIG. 5A shows a generally-known layer 2 VLAN packet 800. This packet 800 is composed of a 4-byte VLAN tag 800a, a 6-byte destination MAC address 800b, a source MAC address 800c, a type 800d, and data 800e. The VLAN structuring packet 701 and the VLAN setup packet 702 are defined in conformity with the VLAN packet 800. FIGS. 5B, 5C and FIGS. 6A-6C respectively show examples of the VLAN structuring (completing) packets 701_1, 701_2, and the VLAN structuring packets 701_3-701_5. FIGS. 7A-7E show examples of the VLAN setup packets 702_1-702_5.

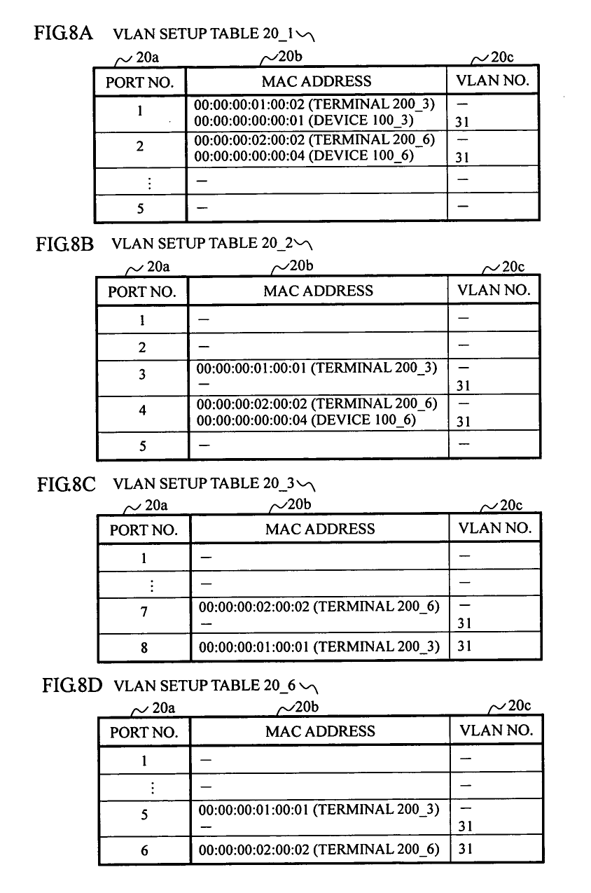

Also, FIGS. 8A-8D show examples of the VLAN setup tables 20_1-20_5, and the VLAN setup table 20 is related to the MAC address learning table.

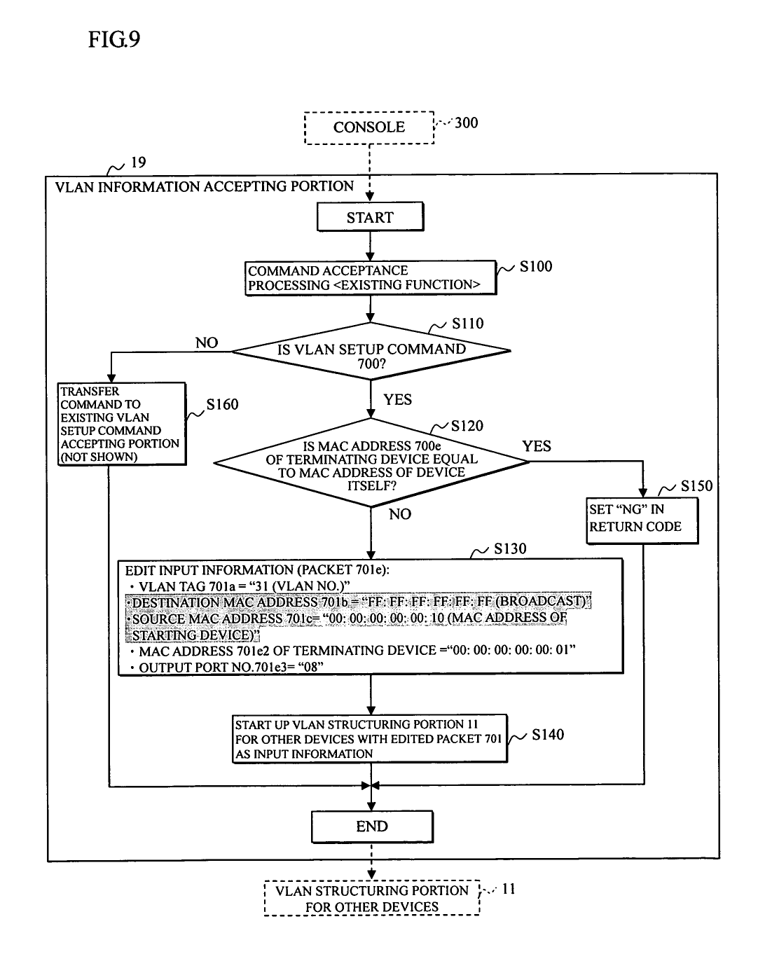

FIGS. 9-17 show operation procedure examples of the functional portions of the network device 100. Namely, FIGS. 9-17 respectively show operation procedure examples of the VLAN information accepting portion 19, the VLAN structuring portion for other devices 11, the VLAN structuring packet transmitter 12, the VLAN structuring packet receiver 13, the VLAN structuring packet relay portion 14, the VLAN setup packet transmitter 15, the VLAN setup packet receiver 16, the VLAN setup portion for the device itself 17, and the command response transmitter 18.

### Operational Embodiment (1): Case Where Path has no Branch

An operation procedure example of setting up the VLAN 31 between the terminals 200_3 and 200_6 in the network shown in FIG. 3 will now be described referring to FIGS. 2, 3, 4A-4E, 5A-5C, 6A-6C, 7A-7E, 8A-8D, and 9-17.

In FIG. 3, the operator 400 firstly transmits the VLAN setup commands 700_1 and 700_2 to the network device 100_1 through the console 300.

FIG. 4A shows a format of the VLAN setup command 700. This command 700 is composed of “SET_VLAN”, <VLAN_No.>, <src_mac>, <dst_mac>, and <dst_port>. Among these, the “SET_VLAN” indicates that the command is the VLAN setup command, the <VLAN_No.> indicates a VLAN No. to be set, <src_mac> indicates the MAC address of the starting device 100, the <dst_mac> indicates the MAC address of the terminating device 100, and the <dst_port> indicates a port No. (output port No.) on a terminal side corresponding to the VLAN of the VLAN_No. in the terminating device 100 designated by the dst_mac.

FIGS. 4B and 4C respectively show the VLAN setup commands 700_1 and 700_2 in FIG. 3. In the VLAN setup command 700_1, the VLAN_No.=“31”, the src_mac=“00:00:00:00:00:10 (MAC address of the network device (starting device) 100_{—}1)”, the dst_mac=“00:00:00:00:00:01 (MAC address of the network device (terminating device) 100_{—}3)”, and the dst_port=“08 (output port No. corresponding to the VLAN No.=“31” in the terminating device 100_{—}3)” are set. In the VLAN setup command 700_2, the VLAN_No.=“31”, the src_mac=“00:00:00:00:00:10 (MAC address of the network device (starting device) 100_{—}1)”, the dst_mac=“00:00:00:00:00:04 (MAC address of the network device (terminating device) 100_{—}6)”, and the dst_port=“06(output port No. corresponding to the VLAN No.=“31” in the terminating device 100_{—}6)” are set.

FIG. 4D shows a modified command 700_3, which is different from the commands 700_1 and 700_2 in that a single command 700_3 designates a plurality of combinations (in FIG. 4D, “n” combinations of <dst_mac1> <dst_port1> <dst_macn> <dst_portn>) of the terminating device and the port No., while the commands 700_1 and 700_2 respectively designate a single combination of the terminating device 100 and the port No. (output port No.) on the terminal side. By this VLAN setup command 700_3, the setup of the VLAN is made possible by a single command.

FIG. 4E shows a modified command 700_4, which is different from the modified command 700_3 in that the <src_port> is added for designating the output port No. While the output port No. from which the structuring packet 701 in the starting device 100 is to be outputted can not be designated by using the modified command 700_3, the output port No. from which the structuring packet 701 is to be transmitted can be designated by the operator's designation of the <src_port> by using the modified command 700_4. Thus, the port No. is designated so as not to transmit the structuring packet 701 reversely, thereby the transmission of a useless structuring packet 701 to be eliminated. In this case, the operator is required to recognize the network configuration.

An operation procedure example of the VLAN information accepting portion 19 of the network device 100_1 having received the VLAN setup command 700_1 from the console 300 will now be described referring to FIG. 9.
Step S100: The accepting portion 19 receives an existing VLAN setup command (not shown) or the VLAN setup command 700_1 from the console 300.
Steps S110 and S160: When receiving the existing VLAN setup command (not shown), the accepting portion 19 provides the command to an existing LAN setup command accepting portion (not shown), so that the accepting portion processes the existing VLAN setup command and ends the operation.
Steps S110, S120, and S150: When the dst_mac of the VLAN setup command 700 is “MAC address of the device itself”, the accepting portion 19 sets “NG” in a return code and ends the operation. Namely, the accepting portion 19 regards the VLAN setup command 700 as an error command and does not accept the command.
Steps S110-S140: When the dst_mac of the VLAN setup command 700_1 is not “MAC address of the device 100_1 itself”, the accepting portion 19 edits input information (e.g. structuring packet 701) to be provided to the VLAN structuring portion for other devices 11 at a subsequent stage based on a destination MAC address=“FF:FF:FF:FF:FF:FF” and a source MAC address (MAC address of the device 100_1 itself) in addition to the VLAN_No., the dst_mac, and the dst_port included in the setup command 700. Namely, the accepting portion 19 edits the structuring packet 701_1 [VLAN tag 701a=“31 (=VLAN_No.)”, destination MAC address=“FF:FF:FF:FF:FF:FF (broadcast)”, source MAC address 701c=“00:00:00:00:00:10 (MAC address of the device itself)”, MAC address 701e2 of the terminating device=“00:00:00:00:00:01 (dst_mac: MAC address of the terminating device 100_{—}3)”, and output port No. 701e3=“08 (dst_port: output port No. of the terminating device 100_{—}3)”] (see step S130 in FIG. 9; a hatched portion indicates data added by the accepting portion 19; it is to be noted that the data indicated at step S130 depends on the setup command 700 or the like). The accepting portion 19 starts up the VLAN structuring portion for other devices 11 with the structuring packet 701_1 as input information and ends the process.

Similarly, the VLAN information accepting portion 19 edits the structuring packet 701_3 [VLAN tag 701a=“31”, destination MAC address=“FF:FF:FF:FF:FF:FF”, source MAC address 701c=“00:00:00:00:00:10”, MAC address 701e2 of the terminating device=“00:00:00:00:00:04 (dst_mac: MAC address of the terminating device 100_{—}6)”, output port No. 701e3=“06 (dst_port: output port No. of the terminating device 100_{—}6)”] corresponding to the VLAN setup command 700_2 having received from the console 300, and provides the structuring packet 701_3 to the structuring portion 11.

It is to be noted that although the structuring packet 701 is edited to be provided to the structuring portion 11 in the above description, it is possible that only known data within the area of the structuring packet 701 is provided to the structuring portion 11, only known data is similarly provided to functional portions of the subsequent stages in the functional portions, which will be described later, and the packet 701 is edited when it is finally required. The same applies to the packet 702, which will be described later.

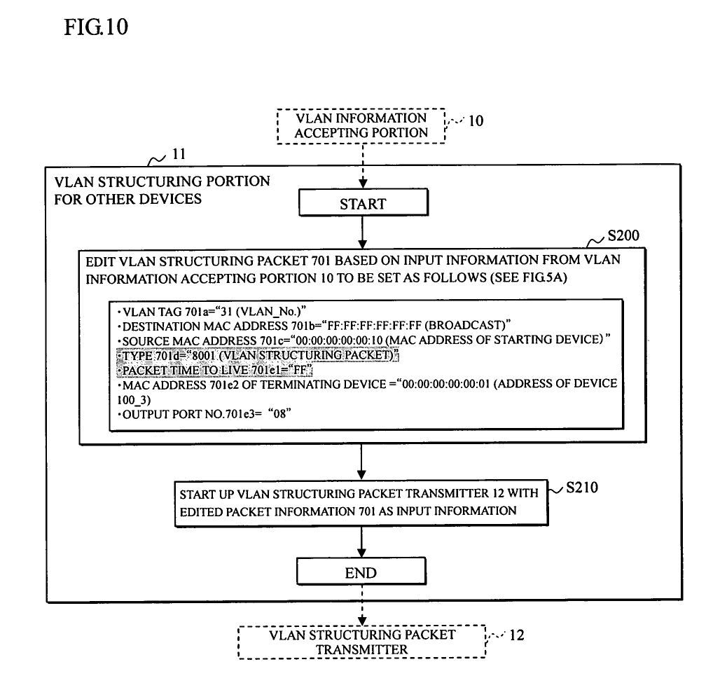

FIG. 10 shows an operation procedure of the VLAN structuring portion for other devices 11. This operation procedure example will now be described.
Step S200: The VLAN structuring portion for other devices 11 edits the VLAN structuring packet 701 based on the input information provided (e.g. structuring packet 701) (see step S200 in FIG. 10; hatched portion indicates data added by the structuring portion 11; it is to be noted that the data indicated at step S200 depends on the setup command 700 or the like).

FIG. 5B shows the VLAN structuring packet 701_1 edited by the structuring portion 11. In the packet 701_1, the VLAN tag 701a=“31”, the destination MAC address 701b=“FF:FF:FF:FF:FF:FF”, the source MAC address 701c=“00:00:00:00:00:10”, a type 701d=“8001”, a packet time to live 701e1=“FF”, the MAC address 701e2 of the terminating device=“00:00:00:00:00:01”, the output port No. 701e3=“08, and an input/output port 701ea2=“00:XX (not-yet-set)” are set.

It is to be noted that while a VLAN setup candidate device 701ea1=“00:00:00:00:00:10”, and the output port No. of the input/output port 701ea2=“01”have been already set in FIG. 5B, they are set by the subsequent VLAN structuring packet transmitter 12.
Step S210: The structuring portion 11 starts up the VLAN structuring packet transmitter 12 with the edited packet 701_1 as input information.

Similarly, the structuring portion 11 edits the structuring packet 701_3 in which information is further added to the structuring packet 701_3 received from the accepting portion 19.

FIG. 6A shows the structuring packet 701_3 edited. In this packet 701_3, the VLAN tag 701a=“31”, the destination MAC address 701b=“FF:FF:FF:FF:FF:FF”, the source MAC address 701c=“00:00:00:00:00:10”, the type 701d=“8001”, the packet time to live 701e1=“FF”, the MAC address 701e2 of the terminating device=“00:00:00:00:00:04”, the output port No. 701e3=“06”, and the input/output port 701ea2=“00:XX (not-yet-set)” are set. It is to be noted that while the VLAN setup candidate device 701ea1=“00:00:00:00:00:10”, and the output port No. of the input/output port 701ea2=“02” have been already set in FIG. 6A, they are set by the subsequent VLAN structuring packet transmitter 12.

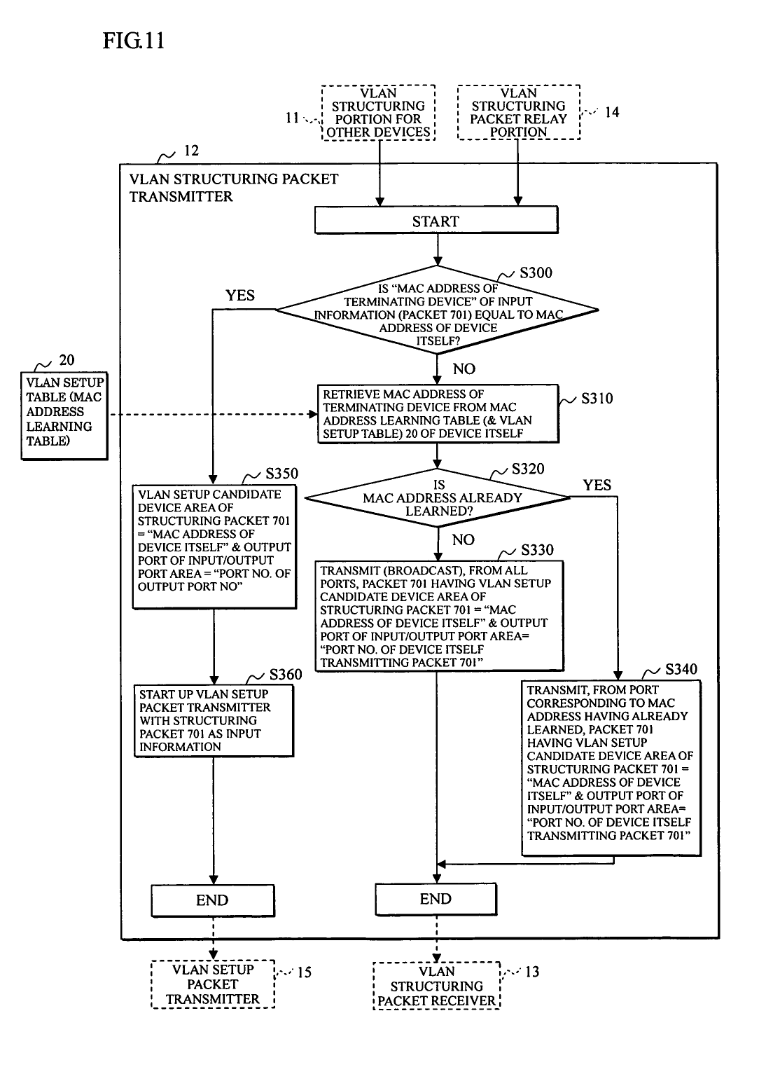

FIG. 11 shows an operation procedure of the VLAN structuring packet transmitter 12. An operation procedure example of the VLAN structuring packet transmitter 12 in the network device (starting device) 100_1 will now be described referring to FIG. 11.
Steps S300-S330: When the MAC address 701e2 of the terminating device in the packet (input information) 701_1 is not the MAC address of the device itself (see step S300; namely, in case where the device itself is not the terminating device), and the MAC address 701e2 of the terminating device has not been learned in the VLAN setup table (MAC address learning table) 20 (see steps S310 and S320), the transmitter 12 transmits from the port No. “1” the packet 700_1 in which the VLAN setup candidate device area of the structuring packet 701=“00:00:00:00:00:10 (MAC address of the device itself)”, and the output port of the input/output port area corresponding to the VLAN setup candidate device=the port No. “1” of the device itself from which the packet 701_1 is to be transmitted have been set (see step S330). Furthermore, the transmitter 12 transmits similar packets 700_i (not shown) to all of the other ports.
Steps S300-S320 and 340: On the other hand, when the MAC address 701e2 of the terminating device in the packet 701 is not the MAC address of the device itself, and the MAC address 701e2 of the terminating device has been already learned in the VLAN setup table 20, the transmitter 12 transmits only from the port No. “1” the packet 700_1 in which the VLAN setup candidate device area of the structuring packet 701=“00:00:00:00:00:10 (MAC address of the device itself)” and the output port of the input/output port corresponding to the VLAN setup candidate device=“port No. “1” having been already learned” have been set, and does not transmit the packet 700 from all of the other ports.

Similarly, the transmitter 12 transmits from the port No. “2” the packet 700_3 in which the VLAN setup candidate device area of the structuring packet 701_3=“00:00:00:00:00:10 (MAC address of the device itself)”, and the output port of the input/output port area corresponding to the VLAN setup candidate device=“port No. “2” of the device itself from which the packet 701_3 is to be transmitted”. Furthermore, the transmitter 12 transmits the similar packets 700_i (not shown) to all of the other ports. Alternatively, when the MAC address 701e2 of the terminating device has been already learned by the VLAN setup table 20, the transmitter 12 transmits only from the port No. “2” the packet 700_3 in which the VLAN setup candidate device area of the structuring packet 701_3=“00:00:00:00:00:10 (MAC address of the device itself)”, and the output port of the input/output port corresponding to the VLAN setup candidate device=“port No. “2” have been already learned” have been set.

Thus, it is supposed that the VLAN structuring packets 701_1 and 701_3 for searching a candidate of the network device for which the VLAN=“31” should be set up are transmitted from the predetermined ports.

It is to be noted that “having been already learned” means that the transmitter 12 searches the VLAN setup table 20 with the MAC address 701e2 of the terminating device in the packet 701_1=“00:00:00:00:00:01”, and finds that a port corresponding to “00:00:00:00:00:01” has been already registered.

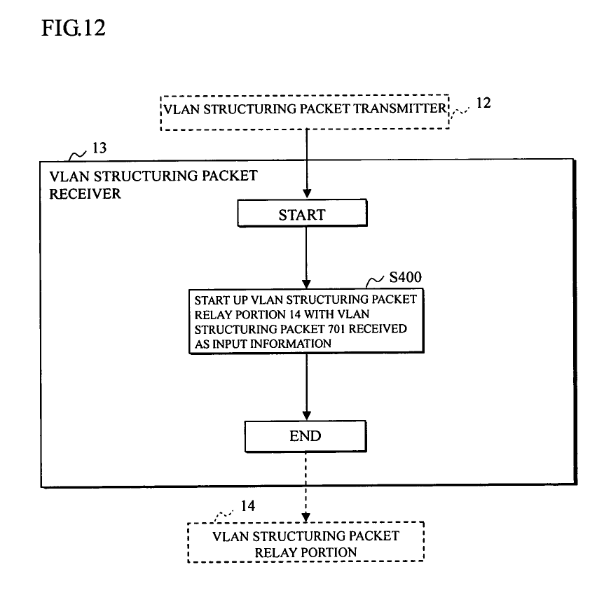

FIG. 12 shows an operation procedure example of the VLAN structuring packet receiver 13 (see FIG. 2). The operation procedure example of the VLAN structuring packet receiver 13 in the network device (terminating device) 100_3 and the network device (relaying device) 100_2 respectively receiving the above-mentioned VLAN structuring packet 701_1 and the VLAN structuring packet 701_3 (see FIG. 3) will now be described referring to FIG. 12.
Step S400: The structuring packet receiver 13 starts up the VLAN structuring packet relay portion 14 with the received VLAN structuring packet 701_1 or 701_3 as input information.

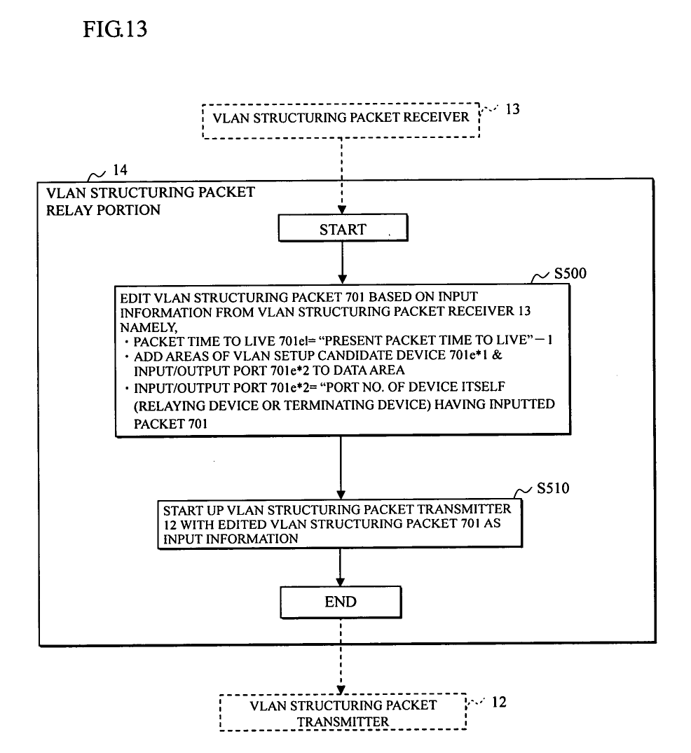

FIG. 13 shows an operation procedure example of the VLAN structuring packet relay portion 14 (see FIG. 2). The operation procedure example of the VLAN structuring packet relay portion 14 of the network device (terminating device) 100_3 and the network device (relaying device) 100_2 respectively having received the above-mentioned VLAN structuring packet 701_1 and 701_3 (see FIG. 3) from the receiver 13 will now be described referring to FIG. 13.
Step S500: The relay portion 14 of the network device 100_3 edits the VLAN structuring packet 701_2 based on the VLAN structuring packet 701_1 received. Namely, the relay portion 14 additionally sets the input/output port 701eb2 of the VLAN structuring packet 701_1=“07 (input port No. having received the VLAN structuring packet 701_{—}1): xx (not-yet-set)”, and edits the VLAN structuring packet 701_2 with the packet time to live 701e1=“FE (=present time to live “FF”−“1”)”.

FIG. 5C shows the VLAN structuring packet 701_2, in which the packet time to live 701e1=“FE” is set, a VLAN setup candidate device 701eb1 and the input/output port 701eb2 are added to data 701eb of the VLAN structuring packet 701_1, and the input port of the input/output port 701eb2=“07” is set. It is to be noted that while the VLAN setup candidate device 701eb1=“00:00:00:00:00:01” and the output port of the input/output port 701eb2=“08” have been already set in FIG. 5C, they are set by the subsequent VLAN structuring packet transmitter 12.
Step S510: The relay portion 14 starts up the VLAN structuring packet transmitter 12 with the edited packet 701_2 as input information.

Similarly, the relay portion 14 of the network device 100_2 additionally sets the input/output port 701eb2=“03:xx (not-yet-set)” in the VLAN structuring packet 701_4 based on the VLAN structuring packet 701_3 received, and edits the VLAN structuring packet 701_4 with the packet time to live 701e1=“FE”.

FIG. 6B shows the VLAN structuring packet 701_4, in which the packet time to live 701e1=“FE” is set. The VLAN setup candidate device 701eb1 and the input/output port 701eb2 are added to the data 701eb of the VLAN structuring packet 701_3, and the input port of the input/output port 701eb2=“03” is set.

It is to be noted that while the VLAN setup candidate device 70leb1=“00:00:00:00:00:20” and the output port within the input/output port 701eb2=“04” having been already set in FIG. 6B, they are set by the subsequent VLAN structuring packet transmitter 12.

The operation procedure example when the VLAN structuring packet transmitter 12 of the network device (relaying device) 100_2 has received the VLAN structuring packet 701_4 will now be described referring to FIG. 11.
Steps S300-S330: Since the MAC address of the device itself is not the MAC address 701e2 of the terminating device=“00:00:00:00:00:04”, and this “00:00:00:00:00:04” is not the MAC address having been already learned, the transmitter 12 transmits from the port No. “4” the VLAN structuring packet 701_4 in which the VLAN setup candidate device 701eb1 of the packet 701_4=the MAC address of the device itself”, and the output port of the input/output port 701eb2=“03 (already set by the relay portion 14): 04 (output port of the device itself)” have been added (see FIG. 6B).

This VLAN structuring packet 701_4 is received by the VLAN structuring packet receiver 13 of the network device (terminating device) 100_6. Furthermore, the packet 701_5 in which areas of a VLAN setup candidate device 701ec1 and an input/output port 701ec2 have been added to data 701ec of the packet 701_4 is edited by the relay portion 14 of the network device 100_6, and the packet time to live 701e1 of the packet 701_5=“FD” (=“FE”−1), and the input port of the input/output port 701ec2=“05” are set, so that the packet 701_5 is provided to the transmitter 12 of the network device 100_6.

FIG. 6C shows the packet 701_5, which is different from the packet 701_4 in FIG. 6B in that the packet time to live 701e1=“FD” is set, the VLAN setup candidate device 701ec1 and the input/output port 701ec2 are added, wherein the VLAN setup candidate device 701ec1=“00:00:00:00:00:04” and the input port of the input/output port 701ec2=“05” are set. It is to be noted that while the VLAN setup candidate device 701eb1=“00:00:00:00:00:20” and the output port within the input/output port 701eb2=“06” have been already set in FIG. 6C, they are set by the subsequent VLAN structuring packet transmitter 12.

The operation procedure of the VLAN structuring packet transmitter 12 in the network devices 100_3 and 100_6 will now be described referring to FIG. 11.
Steps S300 and S350: Since the MAC addresses 701e2 of the terminating devices of the packet 701_2 and the packet 701_5 are respectively the same as the MAC addresses of the devices themselves, the packet transmitter 12 of each of the network devices 100_3 and 100_6 sets the VLAN setup candidate device area=“MAC address of the device itself” and the output port of the input/output port area=“port No. of the output port No. 701e3” (see FIGS. 5C and 6C).
Step S360: The packet transmitter 12 starts up the VLAN setup packet transmitter 15 with the packet 701 as input information.

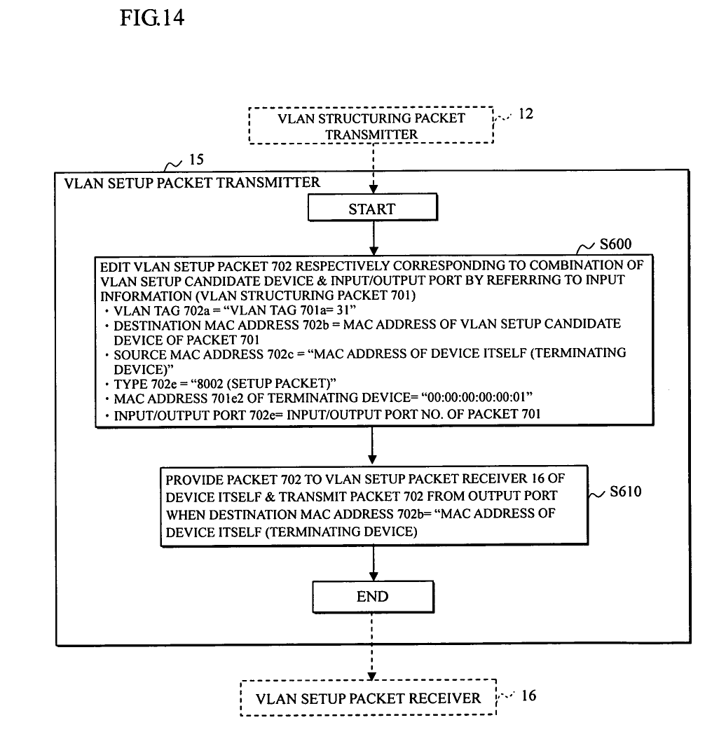

FIG. 14 shows an operation procedure example of the VLAN setup packet transmitter 15 of the network device 100. The operation procedure of the transmitter 15 in the network device 100_3 having received the packet 701_2, and the transmitter 15 in the network device 100_6 having received the packet 701_5 will now be described referring to FIG. 14. The transmitters 15 prepare the VLAN setup packets 702 based on the packets 701 received.
Step S600: The transmitter 12 of the network device 100_3 prepares the VLAN setup packets 702_1 and 702_2 corresponding to two combinations of the VLAN setup candidate device: input/output port of the packet 701_2 received (VLAN setup candidate device 702ea1=“00:00:00:00:00:10”: input/output port 701ea2=“00:01”; VLAN setup candidate device 701ea1=“00:00:00:00:00:01”: input/output port 701ea2=“07:08”).

FIGS. 7A and 7B respectively show the VLAN setup packets 702_1 and 702_2 (hereinafter, occasionally represented by a reference numeral 702). The packet 702 is composed of areas 702a-702g as follows:
VLAN tag 702a=“VLAN tag 701a of the packet 701”
Destination MAC address 702b=“MAC address of the VLAN setup candidate device of the packet 701”
Source MAC address 702c=“MAC address of the device itself”
Type 702d=“8002 (type No. of the VLAN setup packet 702)”
Input/output port 702e=“input/output port No. of the packet 701”
Setup enable/disable 702f=“enable/disable of the VLAN setup is inputted by the VLAN setup portion for the device itself 17, which will be described later”
Data 702g=“NULL”

In the packet 702_1 of FIG. 7A, the destination MAC address 702b=“00:00:00:00:00:10”, the source MAC address 702c=“00:00:00:00:00:01”, the type 702d=“8002”, and the input/output port 702e=“00:01” are inputted.

In the packet 702_2 of FIG. 7B, the destination MAC address 702b=“00:00:00:00:00:10”, the source MAC address 702c=“00:00:00:00:00:01”, the type 702d=“8002”, and the input/output port 702e=“07:08” are inputted.
Step S610: The transmitter 15 transmits from the output port the packet 702_1 whose destination MAC address 702b is not the MAC address of the device itself, and provides to the VLAN setup packet receiver 16 of the device itself the packet 702_2 whose destination MAC address 702b is the MAC address of the device itself.

Similarly, the transmitter 12 of the network device 100_6 prepares the VLAN setup packets 702_3-702_5 based on the packet 701_5 (see FIG. 6C) received.

FIGS. 7C-7E respectively show the VLAN setup packets 702_3-702_5 (hereinafter, occasionally represented by a reference numeral 702).

In the packet 702_3 of FIG. 7C, the destination MAC address 702b=“00:00:00:00:00:10”, the source MAC address 702c=“00:00:00:00:00:04⇄, the type 702d=“8002”, and the input/output port 702e=“00:02” are inputted.

In the packet 702_4 of FIG. 7D, the destination MAC address 702b=“00:00:00:00:00:20”, the source MAC address 702c=“00:00:00:00:00:04”, the type 702d=“8002”, and the input/output port 702e=“03:04” are inputted.

In the packet 702_5 of FIG. 7E, the destination MAC address 702b=“00:00:00:00:00:04”, the source MAC address 702c=“00:00:00:00:00:04”, the type 702d=“8002”, and the input/output port 702e=“05:06” are inputted.

The transmitter 15 transmits from the output port the packets 702_3 and 702_4 whose destination MAC address 702b is not the MAC address of the device itself, and provides to the VLAN setup packet receiver 16 the packet 702_5 whose destination MAC address 702b is the MAC address of the device itself.

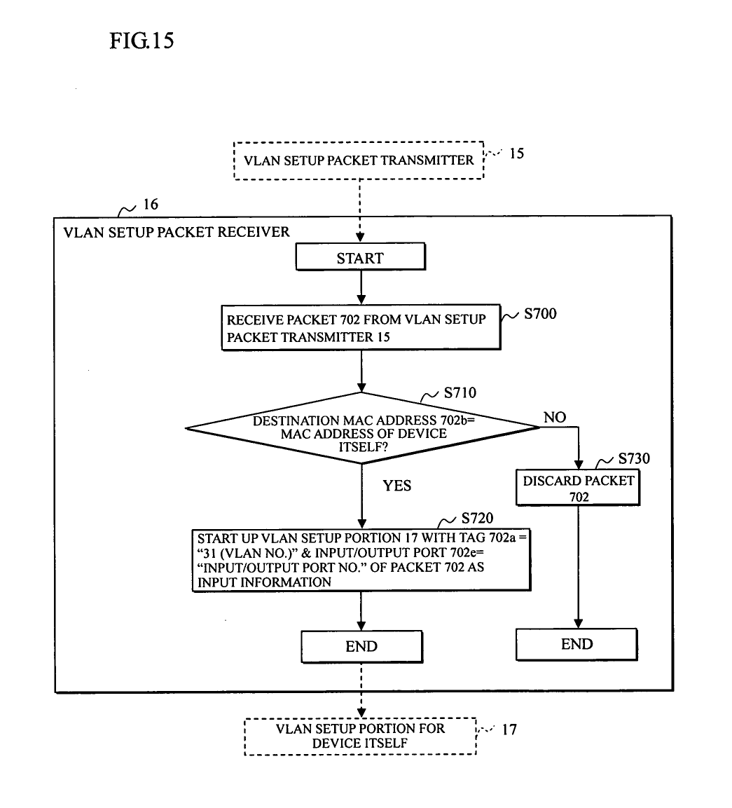

FIG. 15 shows an operation procedure example of the VLAN setup packet receiver 16. Based on this operation procedure example, the receiver 16 of the network device 100_1 receives and processes the packets 702_1 and 702_3, and the receivers 16 of the network devices 100_2, 100_3, and 100_6 respectively receive and process the packets 702_4, 702_2 and 702_5. Firstly, the operation procedure of the receiver 16 of the network device 100_1 will be described.
Steps S700, 710 and 730: The receiver 16 of the network device 100_1 discards the packet 702 not addressed to the MAC address of the device itself.
Steps S700-720: The receiver 16 of the network device 100_1 receives the packets 702_1 and 702_3 addressed to the device itself, and starts up the VLAN setup portion for the device itself 17 with the VLAN tag 702a=“31” and the input/output port 702e=“00:01”, and the VLAN tag 702a=“31” and the input/output port 702e=“00:02” respectively extracted from the packets 702_1 and 702_3 as input information.

Similarly, the receivers 16 of the network devices 100_2, 100_3, and 100_6 respectively receive the packets 702_4, 702_2, and 702_5. It is to be noted that as mentioned above, the packets 702_2 and 702_5 are respectively and directly provided from the transmitters 15 of the devices themselves to the receivers 16 of the network devices 100_3 and 100_6.

Furthermore, the receivers 16 of the network devices 100_2, 100_3, and 100_6 respectively start up the VLAN setup portions 17 for the devices themselves with the VLAN tag 702a=“31⇄ and the input/output port 702e=“03:04”, the VLAN tag 702a=“31” and the input/output port 702e=“07:08”, and the VLAN tag 702a=“31” and the input/output port 702e=“05:06” as input information.

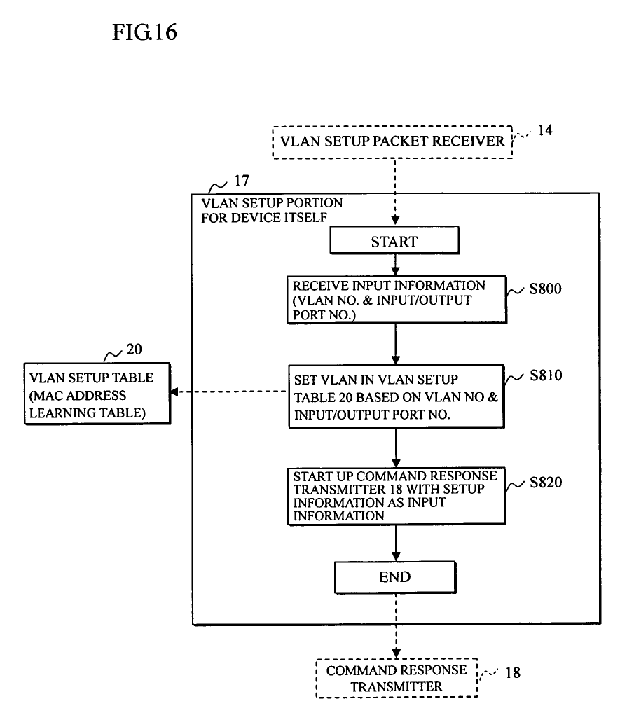

FIG. 16 shows an operation procedure example of the VLAN setup portion for the device itself 17. Based on this operation procedure example, the setup portion 17 of the network device 100 sets up the VLAN in the VLAN setup table 20 based on the input information provided from the receiver 16. Firstly, the operation procedure of the setup portion 17 of the network device 100_1 will be described.
Steps S800 and S801: The VLAN setup portion for the device itself 17 sets the VLAN in the VLAN setup table 20 based on the input information (VLAN tag 702a=“31”: input/output port 702e=“00:01”), (VLAN tag 702a=“1”: input/output port 702e=“00:02”)).

FIGS. 8A-8D respectively show the VLAN setup tables 20_1, 20_2, 20_3, and 20_6 (hereinafter, occasionally represented by a reference numeral 20) of the network devices 100_1, 100_2, 100_3, and 100_6. Each of the VLAN setup tables 20 is associated with the MAC address learning table, and is composed of a port No. 20a, a MAC address 20b, and a VLAN No. 20c.

The setup portion 17 retrieves the port No. 20a=“1” from the VLAN setup table 20_1 (see FIG. 8A) having the same No. as the output port=“01” of the input/output port 702e, referring to the packet 702_1 (VLAN tag 702a=“31”: input/output port 702e=“00:01”), and sets the VLAN No. 20c=“31 (=VLAN tag 702a)” corresponding to the port No. 20a=37 1” (see FIG. 8A). It is to be noted that “00” means “not regulated”, and when the input port of the input/output port 702e=“00” is designated, the VLAN setup is not performed. Also, the setup portion 17 sets the MAC address 20b=“00:00:00:00:00:01 (MAC address of the network device 100_{—}3)” corresponding to the port No. 20a=“1” of the VLAN setup table 20_1, referring to the packet 702_1 (source MAC address=“00:00:00:00:00:01”: input/output port 702e=“00:01”) (see FIG. 8A).

Furthermore, the setup portion 17 associates the VLAN No. 20c=“31” and the MAC address 20b=“00:00:00:00:00:04 (network device 100_{—}6)” with the port No. 20a=“2” of the VLAN setup table 20_1 to be set, based on the packet 702_3 (VLAN tag 702a=“31”: input/output port 702e=“00:02”: source MAC address 702c=“00:00:00:00:00:04”) (see FIG. 8A).
Step S820: The setup portion 17 starts up the command response transmitter 18 with the setup information including a setup enable/disable result as input information.

Similarly, the setup portion 17 of the network device 100_3 sets the VLAN in the VLAN setup table 20_3 based on the packet 702_2 (VLAN tag 702a=“31”: source MAC address 702c=“00:00:00:00:00:01”: input/output port 702e=“07:08”; see FIG. 7B). Namely, the setup portion 17 sets the VLAN No. 20c=“31” in the port Nos. 20a=“7” and “8” of the VLAN setup table 20_3 (see FIG. 8C).

The setup portion 17 of the network device 100_2 sets the VLAN in the VLAN setup table 20_2 based on the packet 702_4 (VLAN tag 702a=“31”: source MAC address 702c=“00:00:00:00:00:04”: input/output port 702e=“03:04”; see FIG. 7D). Namely, the setup portion 17 sets the VLAN No. 20c=“31” in the port No. 20a=“3” of the VLAN setup table 20_3, and associates the MAC address 20b=“00:00:00:00:00:04” and the VLAN No. 20c=“31” with the port No. 20a=“4” to be set (see FIG. 8B).

The setup portion 17 of the network device 100_6 sets the VLAN in the VLAN setup table 20_2 based on the packet 702_5 (VLAN tag 702a=“31”: source MAC address 702c=“00:00:00:00:00:04”: input/output port 702e=“05:06”; see FIG. 7E). Namely, the setup portion 17 associates the VLAN No. 20c=“31” with the port Nos. 20a=“5” and “6” of the VLAN setup table 20_3 to be set (see table 20_6 of FIG. 8D).
Step S820: The setup portion 17 starts up the command response transmitter 18 with the setup information including the setup result as input information.

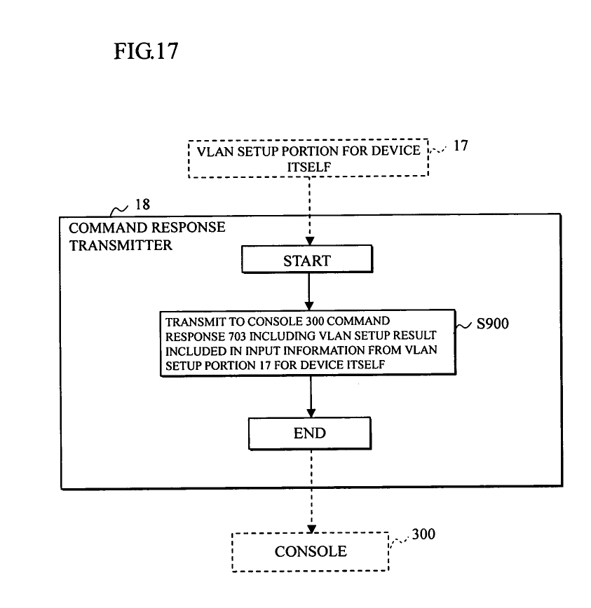

FIG. 17 shows an operation procedure example of the command response transmitter 18, which will now be described.
Step S900: The command response transmitter 18 includes the VLAN setup result included in the input information in the command response 703 to be transmitted to the console 300. The format of the command response 703 is not regulated as long as the MAC address of the device itself and the VLAN setup result may be included in the command response 703. It is to be noted that while the network devices 100_2, 100_3, and 100_6 are not directly connected to the console 300 in FIG. 3, they may be remotely connected to the console 300 and may respond a VLAN setup result of each device.

Alternatively, it is possible that only the VLAN setup result of the network device 100_1 is responded to the console 300 and the VLAN setup result is obtained by accessing all of the network devices 100 from the console 300 by a generally-known method.

### Operational Embodiment (2): Case Where a Path is Branched

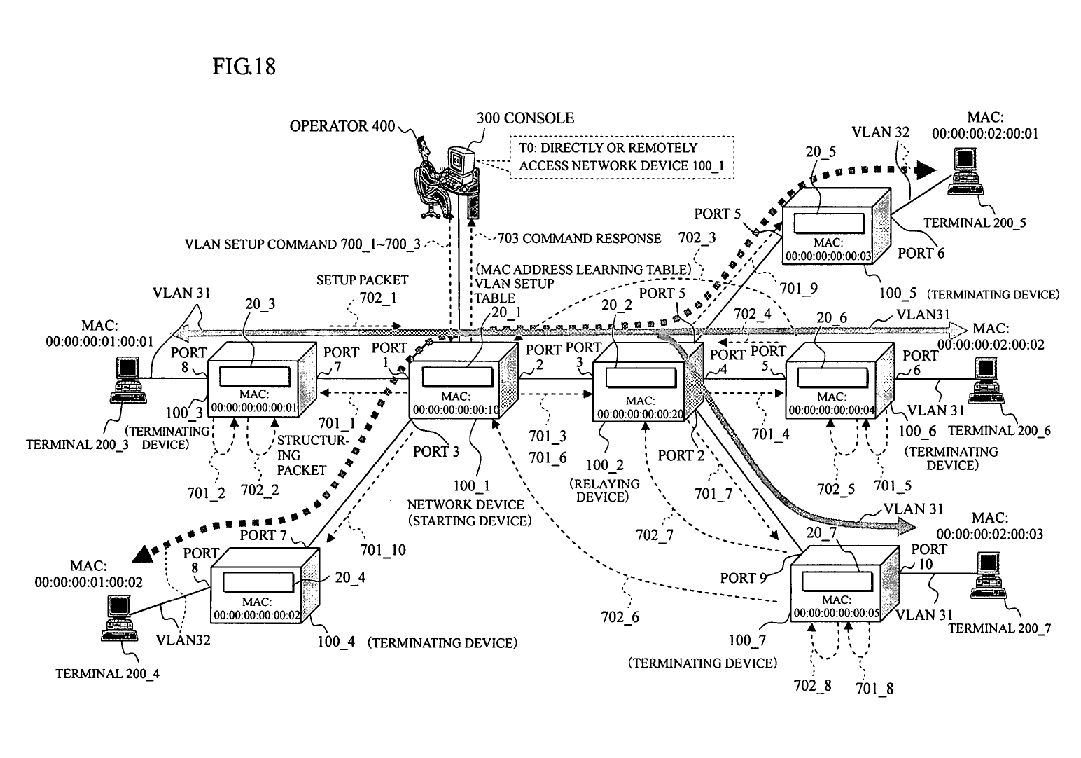

FIG. 18 shows a network configuration in the operational embodiment (2). In this network, a network device 100_4 is branched from the network device 100_1, and the network devices 100_5 and 100_7 are branched from the network device 100_2 in the network configuration shown in FIG. 3. Namely, the port 7 of the network device 100_4 is connected to the port 3 of the network device 100_1, the port 5 of the network device 100_5 and the port 9 of the network device 100_7 are respectively connected to the port 5 and the port 2 of the network device 100_2. Also, terminals 200_4, 200_5, and 200_7 are respectively connected to the network devices 100_4, 100_5, and 100_7.

The MAC addresses of the network devices 100_4, 100_5, 100_7, and the terminals 200_4, 200_5, and 200_7 are respectively “00:00:00:00:00:02”, “00:00:00:00:00:03”, “00:00:00:00:00:05”, “00:00:00:01:00:02”, “00:00:00:02:00:01”, and “00:00:00:02:00:03”.

FIG. 18 shows the state in which the port 8 of the network device 100_3, the port 6 of the network device 100_6 and the port 10 of the network device 100_7 are set to the VLAN 31 (shown by thick arrows), and the port 8 of the network device 100_4, and the port 6 of the network device 100_5 are set to a VLAN 32 (shown by thick dashed line arrow). Namely, the terminals 200_3, 200_6, and 200_7 are mutually connected with the VLAN 31, and the terminals 200_4 and 200_5 are mutually connected with the VLAN 32.

In FIG. 18, the operation procedure of setting the above-mentioned VLAN 31 (thick arrows) by providing the VLAN setup commands 700_1-700_3 to the network device 100_1 by the operator from the console 300 will now be described.

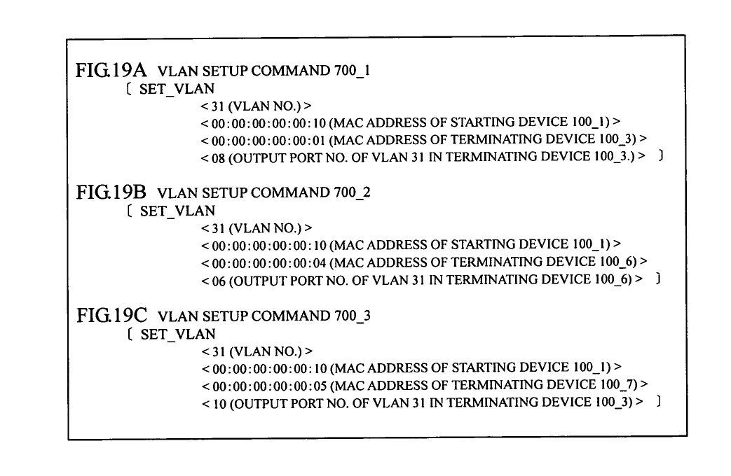

FIGS. 19A-19C respectively show the VLAN setup commands 700_1-700_3 (hereinafter, occasionally represented by a reference numeral 700), and the formats thereof are the same as those shown in FIG. 4A. The VLAN setup command 700_1 is for instructing to set to the VLAN 31 the port No.=“08” of the network device (terminating device) 100_3 whose MAC address=“00:00:00:00:00:01”. The VLAN setup command 700_2 is for instructing to set to the VLAN 31 the port No.=“06” of the network device (terminating device) 100_6 whose MAC address=“00:00:00:00:00:04”, and the VLAN setup command 700_3 is for instructing to set to the VLAN 31 the port No.=“10” of the network device (terminating device) 100_7 whose MAC address=“00:00:00:00:00:05”.

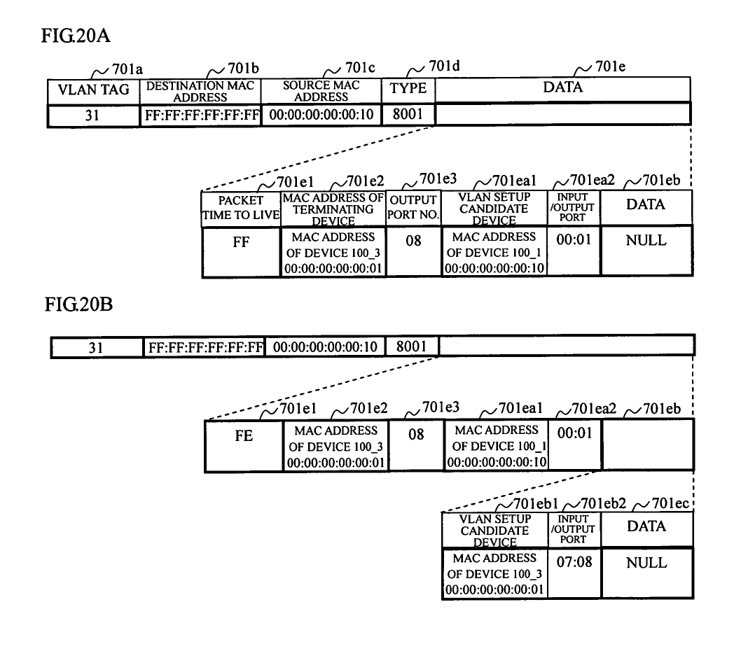

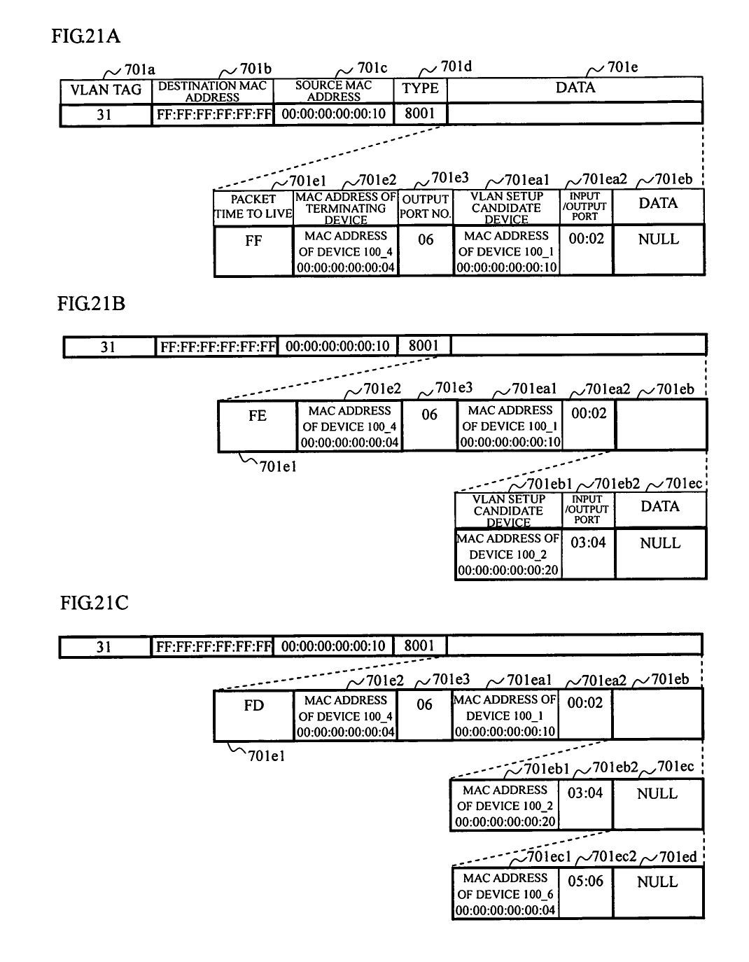

FIGS. 20A, 20B, 21A-21C, and 22A-22C respectively show the VLAN structuring packets 701 transmitted/received between the network devices 100 in the network shown in FIG. 18. Among these, the packets 701_1-701_5 shown in FIGS. 20A, 20B, and 21A-21C are the same as packets 701_1-701_5 shown in FIGS. 5B, 5C, and 6A-6C respectively.

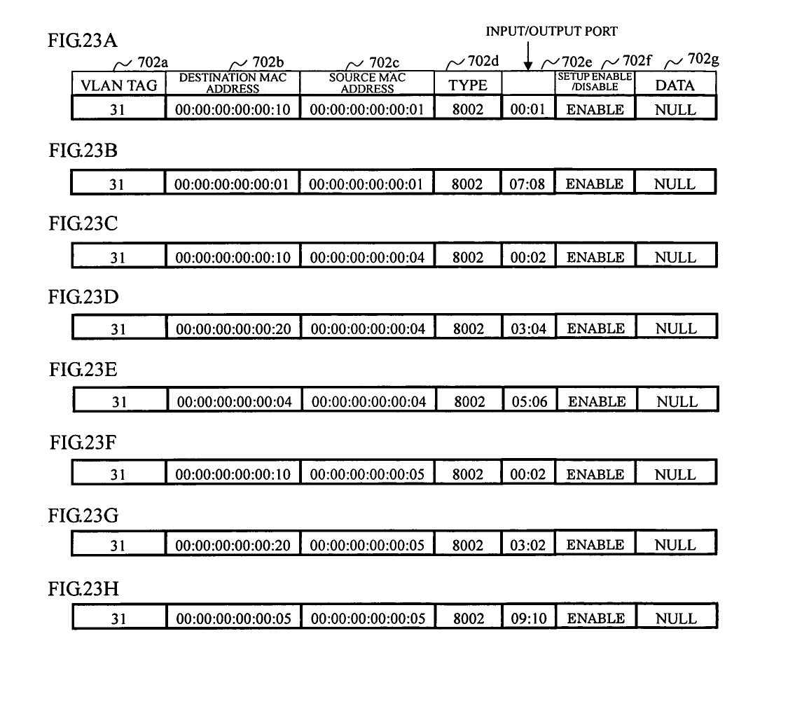

FIGS. 23A-23H show the VLAN setup packets 702 transmitted/received between the network devices 100 in the network shown in FIG. 18. The VLAN setup packets 702_1-702_5 shown in FIGS. 23A-23E are respectively the same as the VLAN setup packets 702_1-702_5 shown in FIGS. 7A-7E.

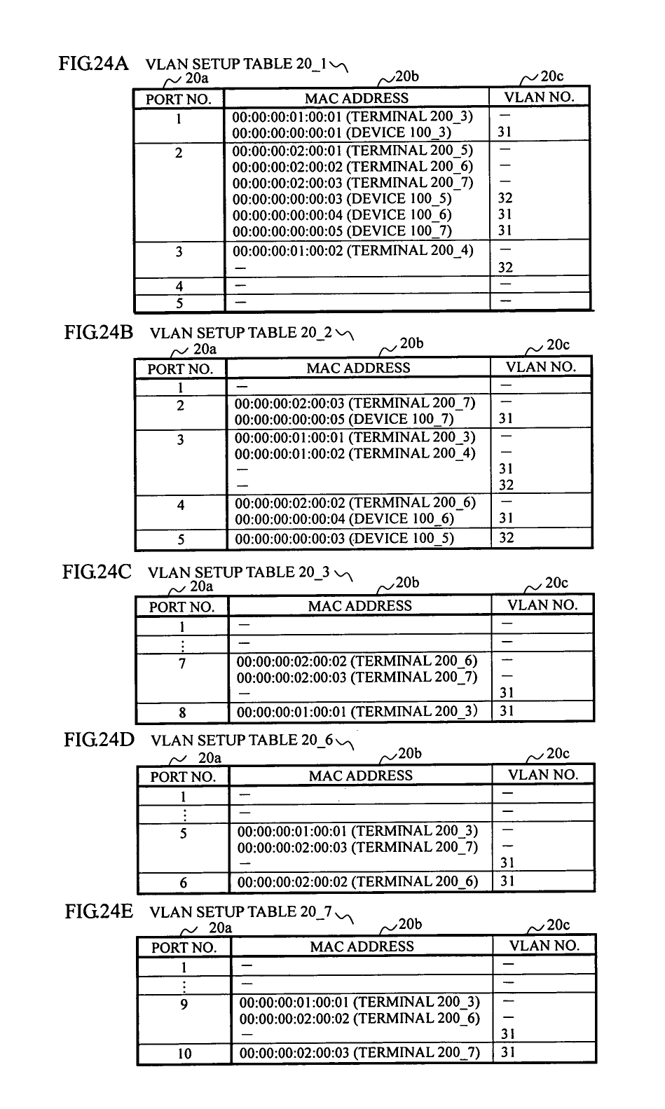

FIGS. 24A-24E respectively show the VLAN setup table 20_1 of the network device 100_1, the VLAN setup table 20_2 of the network device 100_2, the VLAN setup table 20_3 of the network device 100_3, the VLAN setup table 20_6 of the network device 100_6, and the VLAN setup table 20_7 of the network device 100_7 (see FIG. 18). It is to be noted that since the VLAN setup tables 20_4 and 20_5 shown in FIG. 18 are not mutually concerned with the VLAN 32, they are not shown in FIGS. 24A-24E.

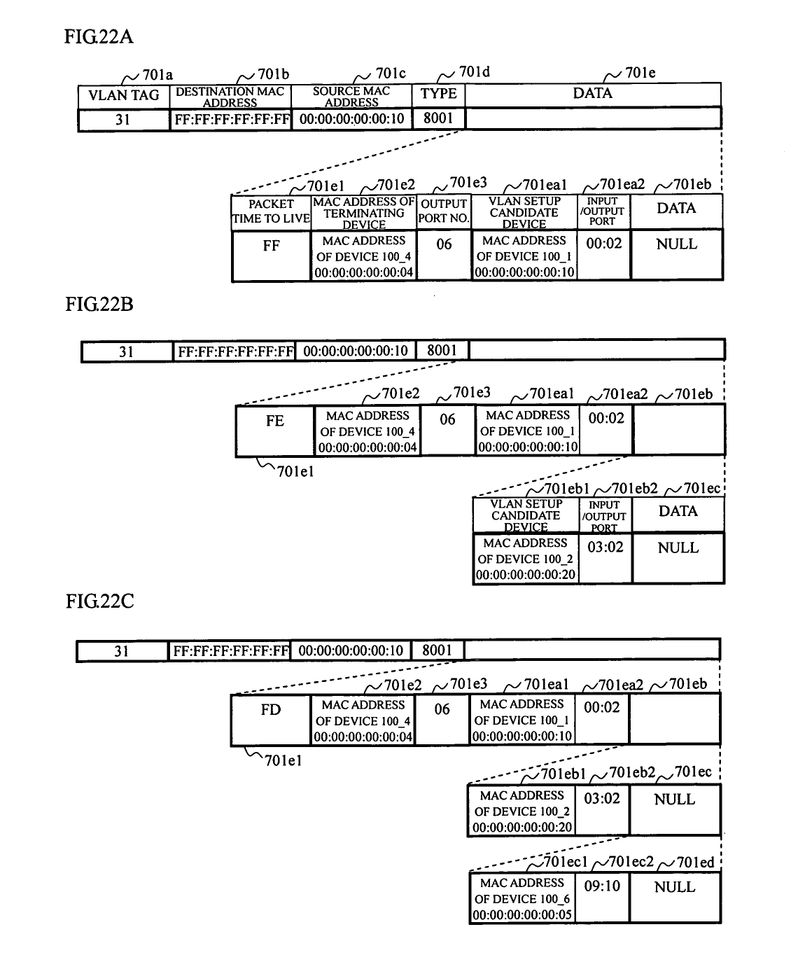

FIGS. 9-17 show the operation procedure examples in which the VLAN 31 is set up based on the VLAN setup commands 700_1-700_3. Hereinafter, only an operation procedure example will be described in which VLAN structuring packets 701_6-701_8 of FIGS. 22A-22C and VLAN setup packets 702_6-702_8 of FIGS. 23F-23H generated based on the VLAN setup command 700_3 specifically among the above-mentioned VLAN setup commands are processed. The operation procedure in which the VLAN structuring packets 701_1-701_5 of FIGS. 20A, 20B, and 21A-21C generated based on the VLAN setup commands 700_1 and 700_2, and the VLAN setup packets 702_1-702_5 of FIGS. 23A-23E are processed is the same as the operation procedure in which the VLAN structuring packets 701_1-701_5 shown in FIGS. 5B, 5C, and 6A-6C of the operational embodiment (1) and the VLAN setup packets 702_1-702_5 of FIGS. 7A-7E are processed. Therefore, the description is hereby omitted.

Firstly, the operation procedure example of the VLAN information accepting portion 19 having received the VLAN setup command 700_3 will be described referring to FIG. 9.
Steps S100-S130: The accepting portion 19 edits the VLAN structuring packet 701_3 corresponding to the VLAN setup command 700_3 respectively. The data determined to be inputted to or inserted into each area of the packet 701_6 is as follows:
Packet 701_6: It is rendered that VLAN tag 701a=“31”, destination MAC address 701b=“FF:FF:FF:FF:FF:FF”, source MAC address 701c =“00:00:00:00:00:10”MAC address 701e2 of the terminating device=“00:00:00:00:00:05”, and output port No. 701e3=“10”.
Step S140: The accepting portion 19 starts up the VLAN structuring portion for other devices 11 with the edited packet 701_6 as input information.

The operation procedure of the VLAN structuring portion for other devices 11 started up with the packet 701_6 as input information will now be described referring to FIG. 10.
Step S200: The VLAN structuring portion for other devices 11 inputs “8001 (indicating VLAN structuring packet)” and “FF” respectively to the type 701d and the packet time to live 701e1 of the packet (input information) 701_6 received. Only the data of an area newly inputted to or inserted into the packet 701_6 is as follows:
Packet 701_6: It is rendered that type 701d=“8001” and packet time to live 701e1=“FF”.
Step S210: The structuring portion 11 starts up the VLAN structuring packet transmitter 12 with the edited packet 701_6 as input information.

The operation procedure example of the VLAN structuring packet transmitter 12 having started up with the packet 701_6 as input information will now be described referring to FIG. 11. It is to be noted that in this description it is supposed that the MAC address 701e2 of the terminating device of the packet 701_6 has been already learned in the VLAN setup table 20_1.
Steps S300-S320 and S340: The transmitter 12 inputs “MAC address of the device itself” and “port No. of the device itself from which the packet 701 is transmitted” respectively to the VLAN setup candidate device 701ea1 and the input/output port 701ea2 of the packet 701_6. Only the data of areas newly inputted to each packet 701_6 is as follows:
Packet 701_6: It is rendered that VLAN setup candidate device 701ea1=“00:00:00:00:00:10” and input/output port 701ea2=“00:02”.

It is to be noted that “00” set in the input port No. of the input/output port 701ea2 means “not specified”.

The packet 701_6 outputted from a predetermined port is received by the VLAN structuring packet receiver 13 of the network device 100_2.

FIG. 12 shows an operation procedure example of the VLAN structuring packet receiver 13 of the network device 100_2 having received the packet 701_6. This operation procedure will now be described.
Step S400: The receiver 13 starts up the VLAN structuring packet relay portion 14 with the received VLAN structuring packet 701_6 as input information.

FIG. 13 shows an operation procedure example of the VLAN structuring packet relay portion 14 of the network device 100_2 having received the packet 701_6. This operation procedure will now be described.
Step S500: The relay portion 14 prepares the areas of the VLAN setup candidate device and the input/output port in the data area with the packet time to live 701e1=“FF”−1=“FE” of the structuring packet (input information) 701_6 received. The relay portion 14 sets the port No. to which the packet 701 is inputted to the input port of the input/output port.

FIG. 22B shows the packet 701_7, which is the packet 701_6 shown in FIG. 22A to which the packet time to live 701e1=“FE”, the VLAN setup candidate device 701eb1=“MAC address of the device itself”, and the input port of the input/output port 701eb2=“port No. of the device itself having inputted the packet 701” are inputted. Only the data of the area newly and additionally inputted to the packet 701_7 is as follows:
Packet 701_7: It is rendered that packet time to live 701e1=“FE”, VLAN setup candidate device 701eb1=“00:00:00:00:00:20”, and input/output port 701eb2=“03:--”. It is to be noted that “--” means “not yet determined”.
Step S510: The relay portion 14 starts up the VLAN structuring packet transmitter 12 with the edited packet 701_7 as input information.

The processing procedure of the packet 701_7 will now be described based on the operation procedure example of the VLAN structuring packet transmitter 12 of the network device 100_2 in FIG. 11. It is supposed that the MAC address 701e2 of the terminating device of the packet 701_7=“00:00:00:00:00:05” has been already learned in the VLAN setup table 20_2.
Steps S300-S320, and S340: The transmitter 12 inputs “MAC address of the device itself” and “port No. (already learned port No.) from which the packet 701 is transmitted” to the VLAN setup candidate device 701eb1 and the input/output port 701eb2 of the packet 701_7 respectively. Only the data of the area newly inputted to the packet 701_7 is as follows:
Packet 701_7: It is rendered that VLAN setup candidate device 701eb1=”00:00:00:00:00:20”, and input/output port 701eb2=“03:02”.

Furthermore, the transmitter 12 transmits the packet 701_7 from the port No. learned. The packet 701_7 is received by the VLAN structuring packet receiver 13 of the network device 100_7.

FIG. 12 shows an operation procedure example of the VLAN structuring packet receiver 13 of the network device 100_7 having received the packet 701_7. This operation procedure will now be described.
Step S400: The receiver 13 starts up the VLAN structuring packet relay portion 14 with the VLAN structuring packet 701_7 received as input information.

FIG. 13 shows an operation procedure example of the VLAN structuring packet relay portion 14 of the network device 100_7 having received the packet 701_7. This operation procedure will now be described.
Step S500: The relay portion 14 prepares the areas of the VLAN setup candidate device and the input/output port in the data area with the packet time to live 701e1=37 FE”−1=“FD” of the structuring packet (input information) 701_7 received. The relay portion 14 sets the port No. of the input port of the input/output port to which the packet 701 has been inputted.

FIG. 22C shows the packet 701_8, that is the packet 701_7 shown in FIG. 22B to which the packet time to live 701e1=“FD”, the VLAN setup candidate device 701ec1=“MAC address of the device itself”, and the input port of the input/output port 701ec2=“port No. of the device itself having inputted the packet 701_{—}7” are inputted. Only the data of the area newly and additionally inputted to the packet 701_8 is as follows:
Packet 701_8: It is rendered that packet time to live 701e1=“FD”, VLAN setup candidate device 701eb1=“00:00:00:00:00:05”, and input/output port 701eb2=“09:--”. It is to be noted that “--” means “not yet determined”.
Step S510: The relay portion 14 starts up the VLAN structuring packet transmitter 12 with the edited packet 701_8 as input information.

The operation procedure example when the VLAN structuring packet transmitter 12 of the network device (terminating device) 100_7 has received the VLAN structuring packet 701_8 will now be described referring to FIG. 11.
Steps S300. S350, and S360: Since the MAC address of the device itself is equal to the MAC address 701e2=“00:00:00:00:00:05” of the terminating device, the transmitter 12 provides to the VLAN setup packet transmitter 15 the VLAN structuring packet 701_4 in which the VLAN setup candidate device 701ec1 of the packet 701_8=“MAC address of the device itself”, and the output port of the input/output port 701ec2=“09 (already inputted by the relay portion 14): 10 (output port No. 701e3 of the packet 701_{—}8)” have been inputted.

FIG. 22C shows the packet 701_8. Only the data of an area newly and additionally inputted to the packet 701_8 is indicated as follows:
Packet 701_8: It is rendered that VLAN setup candidate device 701ec1=“00:00:00:00:00:05”, and input/output port 701ec2=“09:10”.

The operation procedure of the VLAN setup packet transmitter 15 of the network device 100_3 having received the packet 701_8 will now be described referring to FIG. 14. The transmitter 15 prepares the VLAN setup packets 702_6-702_8 (see FIGS. 23F-23H) based on the packet 701_8 (see FIG. 22C) received.
Step S600: The transmitter 15 of the network device 100_7 prepares the VLAN setup packets 702_6-702_8 respectively corresponding to three combinations of the VLAN setup candidate devices: the input/output ports of the packet 701_8 having received (VLAN setup candidate device 701ea1=“00:00:00:00:00:10”: input/output port 701ea2=“00:02”; VLAN setup candidate device 701eb1=“00:00:00:00:00:20”: input/output port 701eb2=“03:02”; and VLAN setup candidate device 701ec1=“00:00:00:00:00:05”: input/output port 701eb2=“09:10”).

FIGS. 23F-23H respectively show the VLAN setup packets 702_6-702_8 (hereinafter, occasionally represented by a reference numeral 702). The VLAN tag 702a=“31”, type 702d=“8002”, setup enable/disable 702f=“enable”, and data 702g=“NULL” of the packet 702 are the same as the data of the packet 702 shown in FIGS. 7A-7E and FIGS. 23A-23E. Also, the source MAC address 702c of the packets 702_6-702_8=“00:00:00:00:00:05” is the MAC address of the network device 100_7 itself.

Data of the VLAN setup candidate device 701ea1-701ec1 and the input/output ports 701ea2-701ec2 of the structuring packet 701_8 are respectively inputted to the destination MAC address 702b and the input/output port 702e of the packets 702_6-702_8.

Thus, it is supposed that data is inputted to the VLAN setup packets 702_6-702_8 in order to set to the VLAN 31 the input/output ports 701ea2-701ec2 of the VLAN setup candidate devices 701ea1-701ec1 collected by the structuring packet 701_8 while passing therethrough from the starting device to the device itself (terminating device having the port corresponding to the VLAN 31).
Step S610: The transmitter 15 provides the packet 702_8 addressed to the device itself to the VLAN setup packet receiver 16 of the device itself, and transmits from the ports the VLAN setup packets 702_6 and 702_7 addressed to other devices. The packets 702_6 and 702_7 are received by the VLAN setup packet receiver 16 of the destination network devices 100_1 and 100_2.

Based on the operation procedure example of the VLAN setup packet receiver 16 of FIG. 15, a processing operation of the packets 702_6-702_8 received by the receiver 16 of the network devices 100_1, 100_2, and 100_7 will now be described.
Steps S700 S710 and S730: The receiver 16 discards the packet 702 not addressed to the device itself.
Steps S700-S720: The receiver 16 receives the packet 702 addressed to the device itself, and starts up the VLAN setup portion for the device itself 17 with the VLAN tag 702a=“VLAN No.”, the input/output port 702e=“input port No.: output port No.” of the packet 702 as input information. Hereinafter, the packets (input information) 702_6-702_8 received by the VLAN setup portions 17 of the network devices 100_1, 100_2, and 100_7 will be described.

It is rendered that:

Input information to the VLAN setup portion 17 of the network device 100_1: VLAN=“31” and input/output port=“00:02”;

Input information to the VLAN setup portion 17 of the network device 100_2: VLAN=“31” and input/output port=“03:02”;

Input information to the VLAN setup portion 17 of the network device 100_7: VLAN=“31” and input/output port=“09:10”.

It is to be noted that the receiver 16 may transfer the packets 702_6-702_8 including the above-mentioned input information unchanged to the VLAN setup portion 17.

Based on the operation procedure example of the VLAN setup portion for the device itself 17 of FIG. 16, the processing operation of the packets (input information) 702_6-702_8 received by the VLAN setup portion 17 of the network devices 100_1, 100_2, and 100_7 will now be described.
Steps S800 and S810: Based on the VLAN No. and the input/output port No. (input information) received, the VLAN setup portion 17 sets the VLAN in the VLAN setup table (MAC address learning table) 20. Namely, the VLAN setup portion 17 associates the VLAN=“31” with the same port as the input/output port No. of the VLAN setup table 20.

FIGS. 24A-24E respectively show the VLAN setup tables 20_1-20_3, 20_6, and 20_7 (hereinafter, occasionally represented by a reference numeral 20) of the network devices 100_1-100_3, 100_6 and 100_7. The arrangement of the table 20 is the same as that of the setup table 20 shown in FIGS. 8A-8D, and is composed of the port No. 20a, the MAC address 20b, and the VLAN No. 20c. Also, the VLAN setup tables 20_1-20_3 and 20_6 of the network devices 100_1-100_3 and 100_6 shown in FIGS. 24A-24D are the same as the tables 20_1-20_3 and 20_6 of the network devices 100_1-100_3 and 100_6 shown in FIGS. 8A-8D. Namely, based on the VLAN setup commands 700_1 and 700_2 (see FIGS. 19A and 19B) the same as the embodiment (1), the data of the MAC address 20b and the VLAN No. 20c collected is set in the tables 20_1-20_3 and 20_6.

However, the MAC address 20b of the terminal 200_7=“00:00:00:02:00:03” is further associated with the port No. 20a learned and is set in the tables 20_1-20_3 and 20_6 of FIGS. 24A-24E. Also, the port No. 20a associated with the VLAN 32 and the MAC address 20b=“00:00:00:00:00:03” of the network device 100_5 are set in the tables 20_1 and 20_2 of FIGS. 24A and 24B. Also, the port No. 20a associated with the VLAN 31 based on the VLAN setup command 700_3 (see FIG. 19C) and the MAC address=“00:00:00:00:00:05” of the network device 100_7 are set in the tables 20_1, 20_2, and 20_7 of FIGS. 24A, 24B, and 24E.

Namely, the setup portion 17 of the network device 100_1 associates the VLAN 31 with the port No. 20a=“2” and the MAC address 20b=“00:00:00:00:00:05” in the setup table 20_1 based on the packet 702_6 (VLAN tag 702a=“31”, source MAC address 702c=“00:00:00:00:00:05”, and input/output port 702e=“00:02”). The setup portion 17 of the network device 100_2 associates the VLAN 31 with the port No. 20a=“3”, and associates the VLAN 31 with the port No. 20a=“2” and the MAC address 20b=“00:00:00:00:00:05” based on the packet 702_7 (VLAN tag 702a=“31”, source MAC address 702c=“00:00:00:00:00:05”, and input/output port 702e=“03:02”). The setup portion 17 of the network device 100_7 associates the VLAN 31 with the port Nos. 20a=“9” and “1038 based on the packet 702_8 (VLAN tag 702a=“31”, source MAC address 702c=“00:00:00:00:00:05”, and input/output port 702e=“09:10”).
Step S820: The setup portion 17 starts up the command response transmitter 18 with the setup information including the setup enable/disable as input information.

FIG. 17 shows an operation procedure example of the command response transmitter 18, which will now be described.
Step S900: The command response transmitter 18 includes the VLAN setup result based on the input information in the command response 703 to be transmitted to the console 300. The format of the command response 703 is not regulated as long as the MAC address of the device itself and the VLAN setup result may be included in the command response 703. It is to be noted that while the network devices 100_2-100_{—}7 are not directly connected to the console 300 in FIG. 18, they may be remotely connected to the console 300 and may respond a VLAN setup result of each device. Alternatively, it is possible that only the VLAN setup result of the network device 100_1 is responded to the console 300 and the VLAN setup result is obtained by accessing all of the network devices 100 from the console 300 by a generally-known method.

Thus, the VLAN setup for all of the network devices concerning the VLAN has been completed.

It is to be noted that the setup operation to the VLAN 32, the VLAN setup command 700 and the setup packet 702 therefor are not shown in FIGS. 18, 19A-9C, 20A, 20B, 21A-21C, 22A-22C, and 23A-23H.

What is claimed is:

1. A starting network device comprising:
a packet transmitter transmitting a structuring packet for structuring a single VLAN after having added thereto an address of the device itself and a port number from which the structuring packet is outputted;
a VLAN setup table;
a packet receiver receiving a setup packet addressed to the device itself in which the port number and the VLAN are associated with each other from a terminating network device designated by the structuring packet; and
a VLAN setup portion setting the received port number and the VLAN associated with each other in the VLAN setup table.

2. The starting network device as claimed in claim 1, further comprising a VLAN information accepting portion inputting from an external device an address of the terminating network device and a port number on a terminal side corresponding to the VLAN to be inserted into the structuring packet.

3. The starting network device as claimed in claim 1, wherein the packet transmitter broadcasts the structuring packet.

4. The starting network device as claimed in claim 1, wherein the VLAN setup table is related to an address learning table associating a port number with an address so that the VLAN is associated with the port number and the address.

5. The starting network device as claimed in claim 4, wherein when a port corresponding to an address of the terminating network device is learned in the address learning table, the packet transmitter transmits the structuring packet to the learned port in place of broadcasting the structuring packet.

6. A relaying network device comprising:
a structuring packet receiver receiving a structuring packet for structuring a single VLAN;
a packet transmitter transferring the structuring packet to which an address of the device itself, a port number to which the structuring packet has been inputted, and a port number from which the structuring packet is to be outputted are added when an address of a terminating network device designated by the structuring packet is not coincident with the address of the relaying network device itself;
a VLAN setup table;
a setup packet receiver receiving from the terminating network device a setup packet addressed to the relaying network device itself in which both port numbers and the VLAN are associated with each other; and
a VLAN setup portion setting the received port numbers and the VLAN associated with each other in the VLAN setup table.

7. The relaying network device as claimed in claim 6, wherein the packet transmitter broadcasts the structuring packet.

8. The relaying network device as claimed in claim 6, wherein the VLAN setup table is related to an address learning table associating a port number with an address so that the VLAN is associated with the port number and the address.

9. The relaying network device as claimed in claim 8, wherein when a port corresponding to an address of the terminating network device is learned in the address learning table, the packet transmitter transmits the structuring packet to the learned port in place of broadcasting the structuring packet.

10. A terminating network device comprising:
a packet receiver receiving a structuring packet for structuring a single VLAN;
a setup information extractor extracting, when an address of a terminating network device designated by the structuring packet is coincident with an address of the terminating network device itself, a port number to which the structuring packet has been inputted, a port number on a terminal side of the terminating network device corresponding to the VLAN designated by the structuring packet, the VLAN designated by the structuring packet, addresses of a starting and a relaying network device designated by the structuring packet, and port numbers of the starting and the relaying network device designated by the structuring packet;
a packet transmitter transmitting for each of the starting and the relaying network device a setup packet in which a respective port number of each of the starting and the relaying network device is associated with the VLAN to each of addresses of the starting and the relaying network device;
a VLAN setup table; and
a VLAN setup portion setting in the VLAN setup table the port number to which the structuring packet has been inputted and the port number on the terminal side corresponding to the VLAN designated by the structuring packet associated with the VLAN.

11. The terminating network device as claimed in claim 10, wherein the VLAN setup table is related to an address learning table associating a port number with an address so that the VLAN is associated with the port number and the address.

12. A network system comprising:
a starting network device transmitting a structuring packet for structuring a single VLAN after having added thereto an address of a terminating network device, a port number on a terminal side corresponding to the VLAN, an address of the starting network device itself, and a port number from which the structuring packet is outputted; and setting in a VLAN setup table of the starting network device itself a port number from which the structuring packet designated by a received setup packet addressed to the starting network device itself is outputted and the VLAN associated with each other;
a relaying network device transferring, when an address of the terminating network device designated by the structuring packet received is not coincident with the address of the relaying network device itself, the structuring packet to which an address of the relaying network device itself, a port number to which the structuring packet has been inputted, and a port number from which the structuring packet is to be outputted are added; and setting in the VLAN setup table of the relaying network device itself a port number to which the structuring packet has been inputted and a port number from which the structuring packet has been outputted, both of which are designated by a received setup packet addressed to the relaying network device itself associated with the VLAN; and
a terminating network device transmitting, when the address of the terminating network device designated by the structuring packet received is coincident with the address of the terminating network device itself, a setup packet in which port numbers for each of addresses of the starting and the relaying network device designated by the structuring packet are associated with the VLAN, to each of addresses of the starting and the relaying network device, and setting in the VLAN setup table of the terminating network device itself a port number to which the structuring packet has been inputted and a port number on a terminal side corresponding to the VLAN and added to the structuring packet associated with the VLAN.
